(19) United States
(12) Patent Application Publication
(10) Pub. No.: US 2008/0050717 A1
(43) Pub. Date: Feb. 28, 2008

(54) Cryopreservation and recovery system for liquid substances

(76) Inventors: William E. Brower JR., Brookfield, WI (US); Louis Kimball Bigelow JR., Oak Harbor, WA (US); David J. Schedgick, Menasha, WI (US)

Correspondence Address: MICHAEL BEST & FRIEDRICH LLP, 100 E WISCONSIN AVENUE, Suite 3300, MILWAUKEE, WI, 53202, US

(21) Appl. No.: 11/881,561

(22) Filed: Jul. 27, 2007

Related U.S. Application Data
(63) Continuation-in-part of application No. 10/136,504, filed on May 1, 2002.

(51) Int. Cl. A01N 1/02

(52) U.S. Cl. 435/2

(57) ABSTRACT

The present invention provides a method of preserving human red blood cells including the acts of cryogenically freezing a number of human red blood cells suspended in a fluid at a rate of 20° C. to 100° C. per second, maintaining a predetermined thickness of the fluid between a pair of plates during freezing of the plurality of red blood cells, and warming the cryogenically frozen red blood cells to an ambient temperature to recover at least some of the red blood cells.

### RELATED APPLICATION

This application is a continuation-in-part of co-pending U.S. patent application Ser. No. 10/136,504, filed May 1, 2002, the entire contents of which is hereby incorporated by reference.

### FIELD OF THE INVENTION

The present invention relates to conversion of a substance from a liquid form to a solid form, in such a manner so as to enable cryopreservation of cells contained within the substance. More particularly, the present invention relates to methods and apparatuses for cryogenically preserving red blood cells.

### SUMMARY

At present, blood and other biologically active substances or materials are cryopreserved by perfusing the substance with a cryoprotective agent and then subjecting the perfused substance to cryopreservation temperatures. This functions to convert cells contained within the substance to a glassy state, which is known to optimize viability of cryopreserved cells. Typical cryoprotective agents are believed to facilitate transformation of the liquid within the cells to a glassy state, and include glycerol, dimethyl sulfoxide, and various other compositions including solutions comprising betaine, sodium chloride and sodium citrate as is disclosed in U.S. Pat. No. 6,037,116, alkoxylated organic compounds such as disclosed in U.S. Pat. No. 5,952,168, or hypotonic cell preservation solutions as disclosed in U.S. Pat. No. 5,769,839. Typically, cryopreservation is accomplished by slowly lowering the temperature of the perfused liquid to a suitable cryopreservation temperature, e.g. 77 to 160 K, and maintaining the cryopreservation temperature for a period of time.

When it is desired to subsequently use the cryopreserved substance, the substance is subjected to a lengthy and gradual warming and de-perfusing process, during which the temperature of the substance is slowly elevated to a desired end use temperature. The use of cryoprotectant compositions is generally thought to minimize the formation of ice crystals, which lyse membranes and other intracellular material and result in destruction of the cell or other biologically active material, and to enhance transformation of liquid within the cells to a glassy. However, it is generally recognized that most cryoprotectant agents have a deleterious effect on a certain percentage of the preserved cells upon re-warming prior to use. Further, the perfused cryoprotectant forms a part of the solution within which the cells are contained after warming. This requires that the cryoprotectant either be removed prior to use, which involves a step that adds time and cost to the process, or that the cryoprotectant be of the type which is less harmful to the environment within which the biological substance is to be employed.

One independent object of the present invention is to provide a cryopreservation technique by converting a liquid to a vitrified solid, having a thickness or volume capable of supporting cells contained within the liquid. Another independent object of the invention is to provide such a cryopreservation system which enables cryopreservation of biological substances without the need for cryoprotective agents. Still another independent object of the invention is to provide such a cryopreservation system which is capable of being used in connection with many types of intracellular and extracellular liquid substances for cryopreservation of biologically active material. Yet another independent object of the invention is to provide such a cryopreservation system having a relatively high degree of simplicity, both in converting the liquid to a vitrified solid and for converting the vitrified solid to its liquid form.

In some embodiments, the present invention provides cryopreservation of biologically active material, such as cells, enzymes, proteins, etc., by vitrification of the cells within a liquid, without the use of cryoprotectant agents. The invention can involve rapidly subjecting the liquid to a temperature sufficient to cause vitrification of the liquid and the biologically active material contained within the liquid, so as to convert the liquid and the biological material to a glass-like vitrified solid form. The liquid can be vitrified in a thickness or volume sufficient to support the biologically active material contained within the liquid, without the addition of cryoprotective agents to the liquid. The vitrified solid can then be maintained at a temperature that is sufficiently low to maintain its vitrified solid form, to store the liquid and the biologically active material for a period of time. The liquid can be vitrified by application of the liquid to a surface that is subjected to low temperatures, such that the vitrification of the liquid occurs by conductive cooling through the surface.

In one form, the liquid can be applied directly to a low temperature surface that functions to vitrify the liquid on contact, and can then be removed from the surface for storage. Alternatively, the liquid can be placed within a receptacle, e.g. a small diameter tube, which in turn is subjected to a low temperature environment sufficient to vitrify the liquid contained within the receptacle. In either form, the liquid and the biologically active material is quickly converted from a liquid state to a glassy state, which is known to provide optimum viability of biologically active material. The vitreous solid can then be stored for a period of time until it is subsequently needed.

To return the biologically active material to a liquid form for use, the vitreous solid can be subjected to a warming process which functions to elevate the temperature of the solid to an extent sufficient to convert the vitrified solid from its solid state to its liquid state. The warming process is accomplished rapidly, to quickly transform the vitreous solid to a liquid state so as to avoid formation of ice crystals during warming. This rapid warming of the material to its liquid form enables rapid utilization of the cryopreserved material when needed.

The cryopreservation system of the present invention has been tested and found to provide cryopreserved viability of blood cells and spermatozoa, and is believed to be applicable to a variety of other types of biologically active material, including, but not limited to, oocytes,

In some embodiments, the present invention provides a method of preserving human red blood cells including the acts of cryogenically freezing a number of human red blood cells suspended in a fluid at a rate of 20° C. to 100° C. per second, maintaining a predetermined thickness of the fluid between a pair of plates during freezing of the red blood cells, and warming the cryogenically frozen red blood cells to an ambient temperature to recover at least some of the red blood cells.

The present invention also provides a method of preserving human red blood cells including the acts of spreading a fluid including a number of human red blood cells, positioning a film across the fluid, applying a liquid interlayer to an exterior surface of the film, and pressing a cold plate against the liquid interlayer to cryogenically freeze the red blood cells in the fluid by thermal conduction.

In some embodiments, the present invention provides a method of preserving human red blood cells including the acts of spreading a fluid including a number of human red blood cells between a pair of substantially parallel plates so as to avoid shearing the red blood cells between the pair of plates, the fluid being substantially glycerol free, cryogenically freezing the human red blood cells, and warming the plurality of red blood cells to an ambient temperature.

Other aspects of the invention will become apparent by consideration of the detailed description and accompanying drawings.

### BRIEF DESCRIPTION OF THE DRAWINGS

FIG. 1A is a photograph of glassy water with some opaque crystalline ice quenched on a diamond wafer having a diameter of 38 mm and a thickness of 0.22 mm at −196° C.

FIG. 1B is a photograph of opaque crystalline ice formed by depositing a 0.057 cm³ water drop on a diamond wafer at room temperature and then slowly cooling the diamond wafer and water disc with liquid nitrogen.

FIG. 2 is a time-temperature cooling curve for water quenched on a diamond wafer.

FIG. 3 is a graphic representation of DSC scan data for quenched glassy water and slowly cooled ice.

FIGS. 4A-4D show DSC plots taken in connection with warming of various samples of red blood cell solution.

FIG. 5 is a flow chart illustrating a method of cryogenically preserving human red blood cells according to a second embodiment of the present invention.

FIG. 6 is a cross-sectional view of an apparatus for cryogenically preserving human red blood cells according to a second embodiment of the present invention.

FIG. 7 is a graphic representation of the temperature profile within a sample as a function of time after contact with a cold plate.

FIG. 8 is a cross-sectional view of an apparatus for warming a number of cryogenically frozen human red blood cells according to some embodiments of the present invention.

FIG. 9 is a graphic representation of a temperature profile of a sample in contact with a heating plate.

FIG. 10A is a magnified view of human blood cells cryogenically frozen in the apparatus and according to the method shown in FIGS. 5-10.

FIG. 10B is a magnified view of human blood cells re-warmed after having been cryogenically frozen in the apparatus and according to the method shown in FIGS. 5-10.

FIG. 11A is a graphic representation of a percentage of human red blood cells recovered from samples processed in the apparatus and according to the method shown in FIGS. 5-9.

FIG. 11B is a graphic representation of a percentage of human red blood cells recovered from samples processed according to an alternative embodiment of the present invention.

FIG. 11C is a graphic representation of a percentage of human red blood cells recovered from samples processed according to a conventional process.

FIGS. 12A and 12B are time-temperature curves showing a percentage of human red blood cell samples processed in the apparatus and according to the method shown in FIGS. 5-9.

FIG. 13 is a table including experimentally-determined conductive heat transfer rates for a variety of materials.

FIG. 14 is a table including test results from methods for cryogenically freezing and recovering human red blood cells according to some embodiments of the present invention.

FIG. 15 is a graph showing cooling rates verses sample thicknesses.

FIG. 16 is a graph showing three sample cooling curves.

FIG. 17 is table showing test results from samples processed in the apparatus and according to the method shown in FIGS. 5-9.

FIG. 18 is a cross-sectional view of a bag for storing and transporting human red blood cells according to the present invention.

FIG. 19 is a cross-sectional view of an apparatus and a method for cryogenically preserving human red blood cells according to a third embodiment of the present invention.

FIG. 20 is a cross-sectional view of an apparatus and a method for cryogenically preserving human red blood cells according to a fourth embodiment of the present invention.

FIG. 21 is a cross-sectional view of an apparatus and a method for cryogenically preserving human red blood cells according to a fifth embodiment of the present invention.

FIG. 22 is cross-sectional view of an apparatus and a method for cryogenically preserving human red blood cells according to a sixth embodiment of the present invention.

FIGS. 23A-23C are flow charts illustrating conventional methods of cryogenically preserving human red blood cells.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” and “having” and variations thereof herein is meant to encompass the items listed thereafter and equivalents thereof as well as additional items.

Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

In addition, it is to be understood that phraseology and terminology used herein with reference to device or element orientation (such as, for example, terms like “front,” “rear,” “top,” “bottom,” “lower”, “up,” “down,” etc.) are only used to simplify description of the present invention, and do not alone indicate or imply that the device or element referred to must have a particular orientation. The elements of the present invention can be installed and operated in any orientation desired. In addition, terms such as “first”, “second,” and “third” are used herein for purposes of description and are not intended to indicate or imply relative importance or significance.

Initial work in connection with the present invention involved the vitrification of water. When it was discovered that water can be converted to a vitrified form in a volume having a thickness sufficient to support biologically active material, such as cells, the steps involved in vitrification of water were applied to liquids containing biologically active material. Tests were performed on the vitrified biologically active material to ascertain the viability of the cryopreserved material. Adaptations in the method were employed so as to result in biologically active material that is taken from a liquid form to a vitrified solid form and then returned to a liquid form, with a high percentage of the biologically active material remaining viable after cryopreservation in this manner.

Initially, the invention contemplates forming vitrified or glassy liquid (e.g. water) in a volume having a thickness known to be sufficient to support biologically active material, such as, for example, cells. The vitrified water can be formed by application of water droplets to a cooling surface, which can be operable to rapidly cool the water by conduction from the surface. The surface can be maintained at a temperature that is sufficient to cause vitrification of the water, without crystallization (i.e. ice formation). This results in the formation of vitrified water particles or discs, which are then removed from the cooling surface and maintained at a temperature sufficiently low so as to maintain the vitrified solid form of the water. The vitrified water can then be warmed to convert it from a solid phase to a liquid phase.

The following Examples are provided for illustrative purposes only. The Examples are included herein solely to aid in a more complete understanding of the presently described invention. The Examples do not limit the scope of the invention described or claimed herein in any fashion.

### EXAMPLE 1

Vitrified or glassy water was formed by rapidly quenching liquid water on a cooling surface. The cooling surface was in the form of a diamond wafer maintained at a temperature of 77 K. The water was formed to a thickness of approximately 0.70 mm, at an in situ measured cooling rate of 110 to 271K/s. The glassy water was transparent, having a density of 104 g/cm³, a glass transition temperature of 138 K, and a crystallization temperature range of 150 to 190 K.

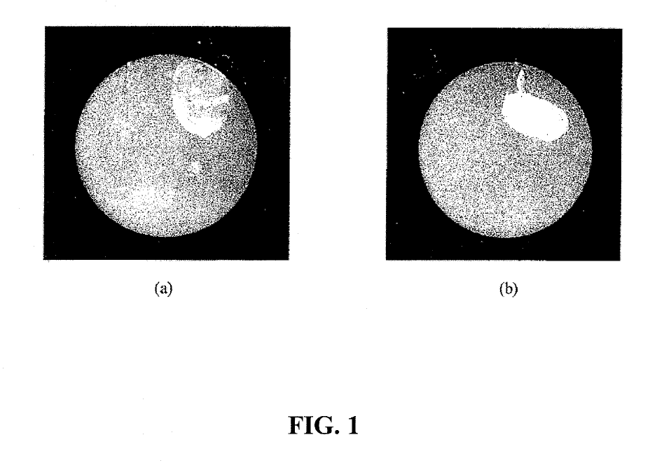

The glassy water was formed in particles or discs having a thickness of approximately 0.70 mm, by dropping 0.057 cm³ of pure water from a syringe onto a cooling surface, in the form of a diamond wafer cooled in liquid nitrogen to 77 K. The diamond wafer was partially submerged into the liquid nitrogen, such that the thermal conductivity of the diamond wafer maintained the exposed area of the diamond wafer at the temperature of the liquid nitrogen, i.e. 77 K. The diamond wafer was maintained at an angle relative to the surface of the liquid nitrogen, e.g. at an angle ranging from 30 degrees to 60 degrees, and preferably approximately 45 degrees. In this manner, water droplets applied to the surface of the diamond wafer are subjected to shearing forces upon impingement with the surface, to provide the water droplets with a relatively thin cross-sectional thickness. FIG. 1A illustrates a disc of glassy water produced in this manner, and the transparency of the disc shown in FIG. 1A represents the conversion of the water droplet to a glass-like or vitrified state, without the formation of ice crystals. The diamond wafer employed in this example was a diamond wafer having a thickness of approximately 0.25 mm and a diameter of approximately 5 cm, such as is available from Norton Diamond Film of Saint-Gobain Industrial Corporation. Such a diamond wafer may be formed in any satisfactory manner, such as by plasma assisted chemical vapor deposition on a substrate that is subsequently removed. By measurement using thermocouples located slightly above the surface of the diamond wafer, cooling rates of up to 271 K/s are observed, within the area to be occupied by water deposited on the diamond wafer. For comparison purposes, FIG. 1B illustrates a similarly sized water droplet slowly cooled, which is opaque and which thus illustrates the formation of ice crystals within the water. In contrast, the glassy water disc of FIG. 1A is transparent over the vast majority of its surface area, which illustrates vitrification of the water. Certain opaque areas in the glassy water disc of FIG. 1A illustrate that some crystallization occurred during the quenching processing. In tests, most of the glassy water discs produced were fully transparent, indicating full vitrification of the disc.

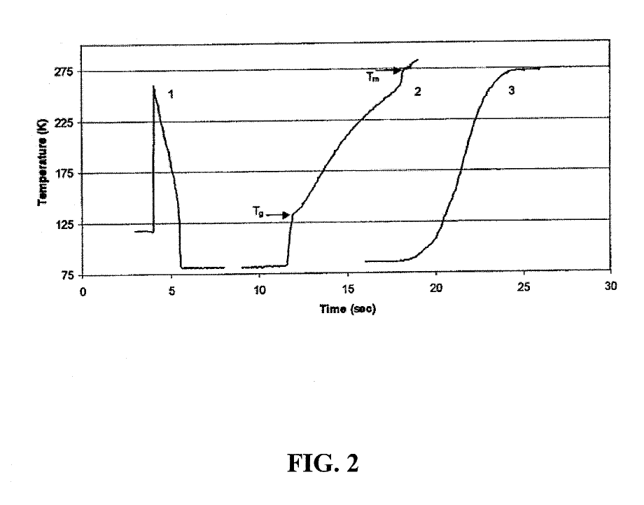

FIG. 2 illustrates in situ thermocouple cooling and reheating curves for a disc of water applied to the cooling surface, during formation as glassy water on the diamond wafer maintained at 77 K. The average cooling rate for curve 1 was 110K/s during quenching of the liquid water from 300K to 77K. No detectable crystallization exotherms occurred, which would have been manifested as a decrease in the cooling rate. Subsequent to formation of the glassy water disc, the disc was reheated at an average reheating rate, from 80 to 135K, of 180K/s, as shown in FIG. 2. During reheating, a glass transition endothermic slope change, labeled at T_{g}, occurred at 135K, after which the heating rate slowed to 28K/s. At higher temperatures, 140 K to 240 K, a slow exothermic crystallization of the glassy water caused a slight increase in the heating rate. At 248 K, the heating rate decreased, indicating the completion of the exothermic transformation. A melting endotherm, labeled Tₘ, occurred at 273 K, which is the melting point of hexagonal ice. The endothermic glass transition shift and the broad crystallization exotherm on curve 2 are both absent in curve 3, which represents a reheating curve for a slowly cooled crystalline ice disc.

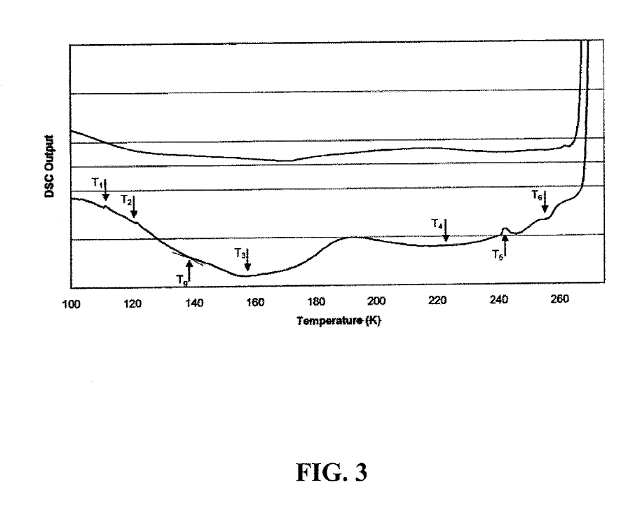

The in situ thermocouple heating curves of FIG. 2 were corroborated by differential scanning calorimetry (DSC) preformed on a glassy water disc formed on the diamond wafer at 77K, and then removed from the diamond and inserted directly onto the DSC stage, which was precooled to 77 K. For comparison, ice formed by slow cooling a water disc to 77 K on the diamond film was also heated in the DSC. FIG. 3 shows the two DSC scans resulting from heating the glassy water disc and the ice disc at 30 K/min. For the rapidly quenched glassy water disc, exotherms at 111K and 121K, shown at T₁ and T₂ in FIG. 3, are near the exothermic transition from high density amorphous (HDA) water to low density amorphous (LDA) water at 120 K. These two peaks are absent on the ice thermogram. Upon further heating of the glassy water disc, an endothermic slope change characteristic of a glass transition occurred at 138 K, as indicated by T_{g}, close to the 135K T_{g} reported for LDA water formed from both vapor deposited amorphous solid water and for glassy water discs. Again, this feature is missing on the ice thermogram. A diffuse exotherm, occurring for the glassy water disc over the range of 150 to 190 K, indicated by T₃, may be the result of crystallization of the glassy water disc to cubic ice. Another broad exotherm, labeled T₄, occurred at 223 K for the glassy water disc, but was absent for the ice. A melting endotherm for both discs occurred at 273 K.

The density of the glassy water disc was measured to be 1.04 g/cm³ by weighing an as-quenched disc in liquid nitrogen and in the nitrogen vapor over the liquid. As a calibration, the procedure was repeated on a larger disc of slowly cooled hexagonal ice, which showed a density at 77 K to be 0.922 g/cm³ (close to the accepted value of the density of hexagonal ice at 77 K of 0.93 g/cm³). Other quenched glassy water discs were weighed in liquid nitrogen and then submerged in a liquid-solid pentane slush for 1 minute at 143 K, a temperature well above the transition temperature of HDA to LDA of 120 K, and below the crystallization temperature of 150 K. The density was then measured again in liquid nitrogen. Densities of other glassy water discs were measured after equilibrating in a freezer for 25 minutes at 255 K, well above the LDA crystallization temperature. The density of the glassy water was determined to be 1.04±0.001 g/cm³, over an average of 5 discs. The glassy water discs floated in liquid oxygen (which has a density at 90K of 1.14 g/cm³). After exposure to 143K in the pentane slush, the glassy water density dropped to 0.935 g/cm³, which is close to the measured density of 0.94 g/cm³ for LDA. After exposure to temperatures of 255 K, the glassy water disc density dropped still further to 0.924 g/cm³, which is close to the measured density of 0.922 g/cm³ for slowly cooled crystalline ice at 77 K.

The high thermal conductivity of the diamond wafer utilized in this example was measured to be 14 W/cm K by the manufacturer. Use of this material as a conductive heat transfer medium allowed cooling rates that have not previously been attainable in quenching relatively thick volumes of liquid water, and enabled cooling rates that avoided crystallization of the water which are far lower than previously expected.

The concomitant thicker section and larger volume of glassy water vitrified in this manner has caused the inventors to investigate use of this technology for other applications. Specifically, the inventors have theorized and proven that vitrification of liquid in this manner is sufficient to support biologically active material that may be contained within a liquid, for cryopreservation of such biologically active material. It is considered that material capable of being cryopreserved in this manner include any and all types of biologically active material. Examples include, but are not limited to, blood, blood components such as red blood cells, spermatozoa, proteins, enzymes, peptides, biological molecules and macromolecules, serums, vaccines, viruses, liposomes, stem cells, bone marrow cells, oocytes, bacterial cells, microorganisms, individual cell types, cell lines, etc. It is also contemplated that multicellular structures, such as organs, tissues or embryos, may be cryopreserved in a similar manner.

In order to cryopreserve biologically active material in this manner, the biologically active material is first obtained and then maintained in a liquid substance. The liquid substance is then rapidly quenched or cooled by contact with a cooling surface in a volume sufficient to support units (e.g. cells) of the biologically active material, so that the substance is converted to a solid glassy state, or vitrified, by conductive cooling from the cooling surface. The vitrified substance is then maintained in its vitrified solid state for a period of time, and is then subjected to a warming process by which the substance is converted from its vitrified state back to its liquid state for use. The rapid quenching or cooling of the substance serves to quickly vitrify the biologically active material as well as the liquid substance within which the biologically active material is contained. This rapid vitrification of the biologically active material functions to quickly convert the biologically active material to the glassy form, which is known to provide optimal viability in a cryopreservation process, without ice crystallization and without the use of cryoprotective agents. Subsequently, the vitrified substance is warmed so as to return the substance to its liquid form, which is operable to immediately return the biologically active material to its original state in preparation for use, without the need for de-perfusion as in the prior art.

### EXAMPLE 2

Red blood cells were isolated placed in an isotonic solution. As a reference, the red blood cell solution was first slowly cooled and slowly warmed. Using microscopy, it was determined that this procedure resulted in complete destruction of the cells (i.e. no recognizable cells were observed). In accordance with the invention, the same red blood cell solution was rapidly quenched using the process as set forth above, by application to the diamond wafer surface maintained at 77 K. Using an intermediate warming process (approximately 10 K/s) in which the cold diamond wafer was placed on a table top and allowed to warm to room temperature, recognizable cells were visible in the amount of approximately 25%. Using a rapid warming process (approximately 50 K/s), in which the quenched droplets of blood cell solution were warmed on the diamond wafer by hand contact, recognizable cells were again visible in the amount of approximately 50%.

Another test involved rapid quenching of the red blood cell solution as set forth above, and warming the droplets of red blood cell solution between a pair of diamond wafers at approximately 100 K/s. Blood cell samples were gathered by irrigating the wafers with isotonicsolution and collecting the liquid in a beaker. This process resulted in a cell survival of approximately 67%. Additional testing was conducted to rapidly quench the blood cell solution between a pair of diamond wafers rather than using a single wafer.

Yet another test involved placing the red blood cell solution in a receptacle having a small passage or space sufficient to support the red blood cells, and rapidly quenching the red blood cell solution by rapidly cooling the receptacle. In this test, the red blood cell solution was placed in a small diameter glass hematocrit tube (having an inside diameter of approximately 0.29 mm and a wall thickness of 0.46 mm) and a clay stopper was inserted into the open end of the tube. The hematocrit tube was then placed directly in liquid nitrogen to rapidly cool the tube and the blood cell solution to 77 K. The estimated cooling rate was approximately 100 K/s. Subsequently, the tube was warmed by rolling it between the hands, to provide a warming rate of approximately 50 to 100 K/s. In addition, warming was also accomplished by placing the tube in a body temperature liquid (e.g. methanol) bath at 37 C, to provide a warming rate of approximately 50 to 100 K/s. This functioned to raise the temperature of the tube and the quenched blood cell solution contained within the tube. Observations showed that this method attained a survival rate of over 96%.

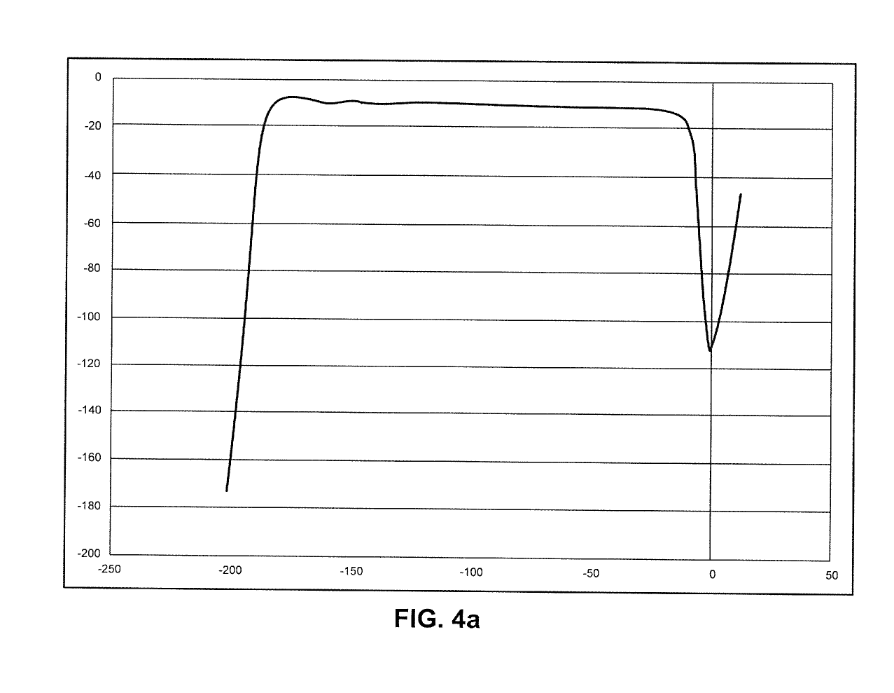

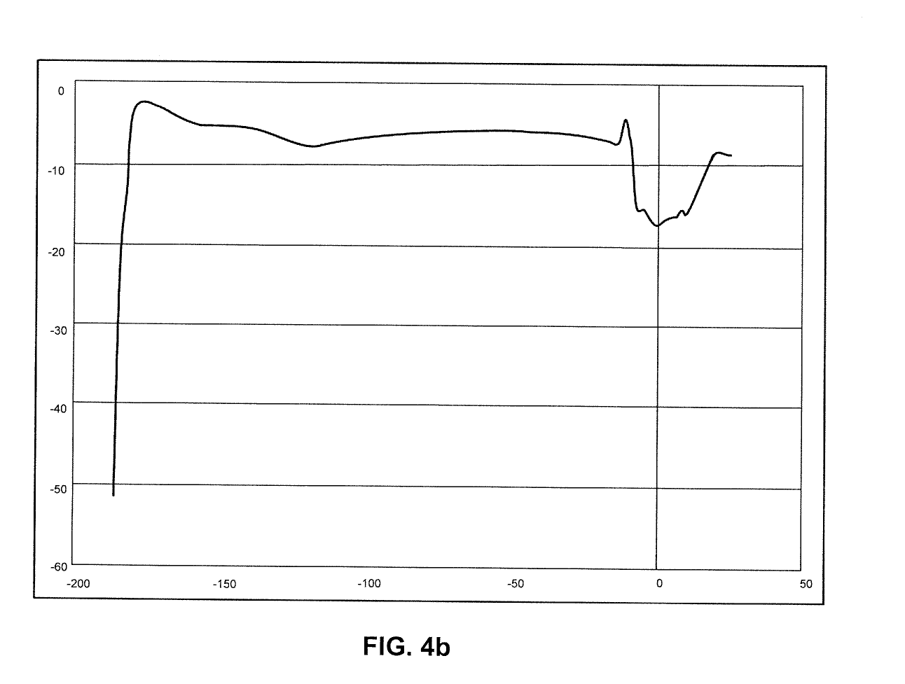

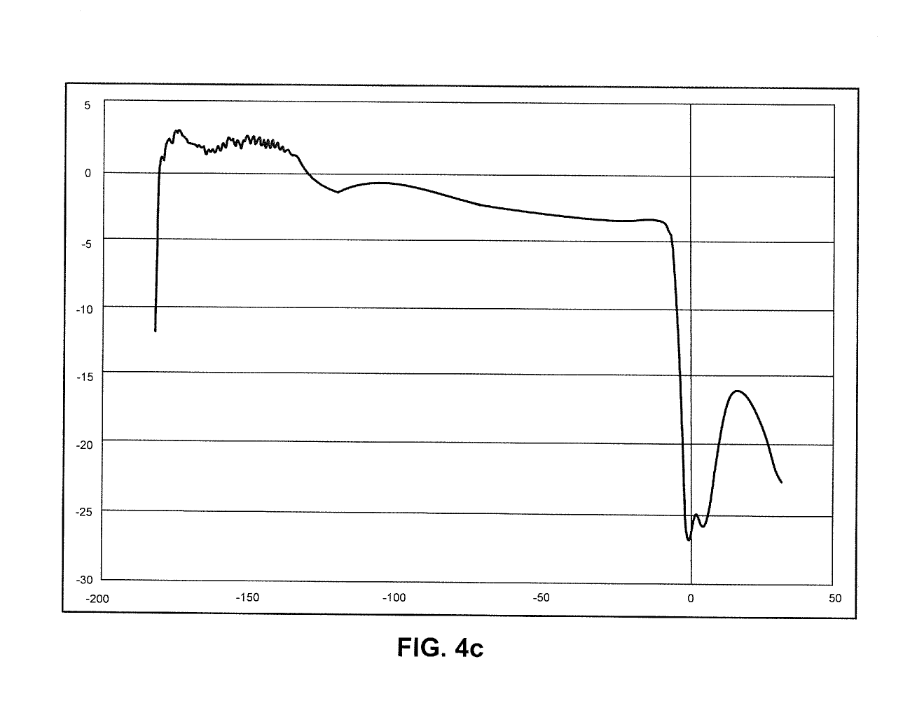

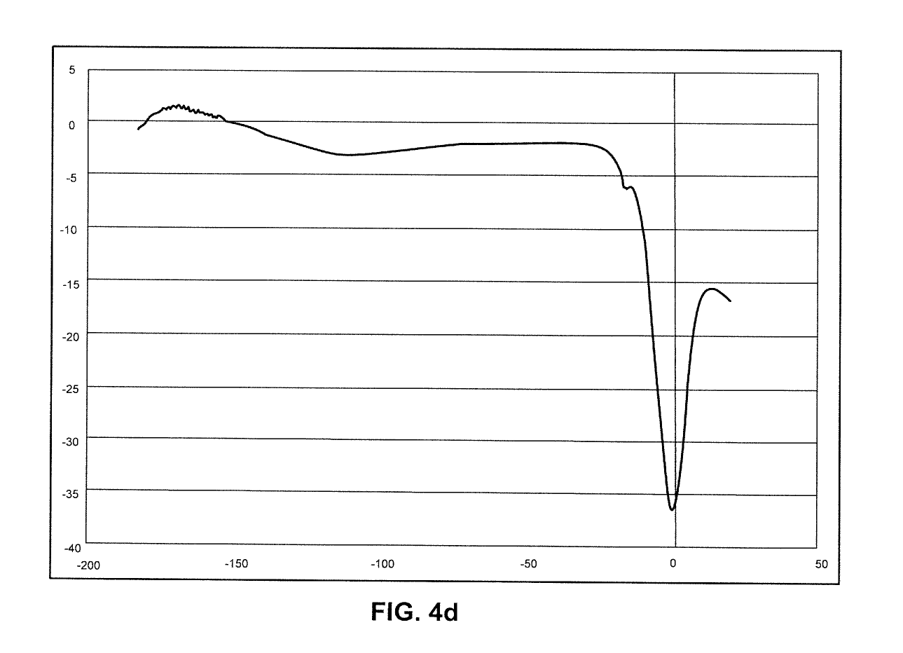

FIGS. 4a through 4d show DSC plots taken in connection with warming of various samples of red blood cell solution. These figures indicate enthalpy changes of the vitrified solid red blood cell solution, with respect to an inert reference. In these plots, a downward peak is endothermic, e.g. the melting of ice which required 80 cal/gm. Such a peak is used as a calibration, since all ice must melt at 0 C (a thermal arrest which causes a differential peak) before heating can proceed. The plots of FIGS. 4a through 4d were obtained glassy red blood cells diluted with 40% isotonic saline and heparinized to prevent clotting, by quenching the solution contained within small diameter (0.29 mm) hematocrit tubes directly into liquid nitrogen. Pieces of the tube containing the quenched red blood cell solution were broken to fit the pan of the DSC, and quickly placed on the DSC pan at approximately −180 C. The DSC was then reassembled, and heating proceeded at a rate of approximately 30 C/min.

For the sample used in the DSC plot of FIG. 4a, the hematocrit tube was first suspended in the liquid nitrogen vapor to slowly cool over several minutes to attain a cooling rate of approximately 1 K/s, prior to full immersion on the liquid nitrogen. The ice endotherm at 0 C is present as a sharp downward peak. Other small endotherms are visible at about −10 C, which are believed to be related-to the presence of about 1% salt in the saline solution and indicate melting of the water-salt eutectic two-phase mixture of ice and salt.

For the sample used in the DSC plot of FIG. 4b, the hematocrit tube containing the red blood cell solution was quickly immersed in the liquid nitrogen in less than one second, to attain a cooling rate of approximately 50 to 100 K/s. Two pieces of the broken tube containing the quenched red blood cell solution were placed on the pan of the DSC. In this plot, there is an unmistakable exotherm at approximately −11 C, which indicates crystallization of a glass. There is also a broad exotherm occurring over the range of approximately −120 C to approximately −20 C. In addition, a glass transition slope change is present at approximately −140 C. After the exotherms, there are the expected endotherms indicating melting of the equilibrium phases that crystallized from the metastable glass or glasses. This scan proves that the direct and rapid immersion process functions to convert the liquid to a glassy state without the use of cryoprotective compositions. As set forth above, test results showed that the red blood cells remained viable using this process.

The sample used in the DSC plot of FIG. 4c was quenched in the same manner as the sample used in the plot of FIG. 4b. In this sample, one piece of the broken tube containing the quenched red blood cell solution was placed on the pan of the DSC. FIG. 4c shows the presence of a similar broad exotherm over the range of approximately −120 C to −20 C. A broad exotherm also exists at approximately −12 C, showing crystallization of the glass. A glass transition also occurs at approximately −130 C.

The sample used in the DSC plot of FIG. 4d was a droplet of red blood cell solution that was applied to a diamond wafer as set forth above, which was removed from the surface of the wafer and placed in the pan of the DSC. This sample exhibited generally similar endotherms and exotherms as in the samples of FIGS. 4b and 4c.

It is understood that the illustrated DSC plots were obtained to verify the conversion of the red blood cells (and the liquid containing the red blood cells) to a glassy state upon quenching, and show thermal characteristics that occur during slow warming. The method of the present invention involves rapid warming of the quenched glassy cells, as set forth above, which functions to optimize the survival rate of the cells.

### EXAMPLE 3

Tests were performed on collected human spermatozoa to ascertain the motility of the spermatozoa after rapid cooling and subsequent warming.

Initial success was obtained using a large diameter (approximately 1.5 mm od, 1.15 mm id, wall thickness 0.17 mm) hematocrit tube within which the diluted spermatozoa solution was placed. The tube was stopped with a clay stopper and immersed directly into liquid nitrogen, to rapidly quench the spermatozoa and liquid. Subsequently, the tube was warmed by placing it into a liquid (water) bath at approximately 37 C, to attain a heating rate of approximately 50 K/s. The sample was then placed onto a microscope slide, and 2% to 4% motility of the cells was observed.

Another sample was rapidly quenched in a similar large inside diameter hematocrit tube as above, and subsequently warmed by rolling the tube between the hands, to attain a heating rate of approximately 40 K/s. The sample was then placed on a microscope slide, and 20% to 30% motility of the cells was observed.

Another test involved the placement of the dilute spermatozoa solution into a small diameter hematocrit tube, which was then rapidly quenched by direct immersion into the liquid nitrogen as set forth above. The tube was subsequently warmed by rolling between the hands, to attain a heating rate of approximately 40 K/s. The sample was then placed on a microscope slide, and 4% to 8% motility of the cells was observed.

In another test, the dilute spermatozoa solution was rapidly quenched by application to the exposed surface of a diamond wafer partially submerged in liquid nitrogen, as set forth above. The quenched sample was then sandwiched between a pair of diamond wafers at body temperature and warmed. The sample was then placed on a microscope slide, and approximately 1% motility of the cells was observed.

In additional tests, neat (undiluted) human semen was placed directly into hematocrit tubes, and then rapidly quenched by immersion into liquid nitrogen. The quenched samples were subsequently warmed. In one test, a neat sample was quenched in a large diameter tube as set forth above, and then warmed by immersion in a 37 C water bath, to attain a heating rate of approximately 50 to 100 K/s. Approximately 10% motility was observed in one test, and approximately 20% motility of the spermatozoa was observed in a test of a different sample. In another test, a neat sample was quenched in a large diameter hematocrit tube as set forth above, and then warmed by rolling the tube between the hands, to attain a heating rate of approximately 40 K/s. Approximately 1% to 2% motility of the spermatozoa was observed in two separate tests of different samples. Using small diameter hematocrit tubes as set forth above, 2% to 4% motility was observed when the quenched sample was warmed by immersion in a 37 C methanol bath (60 K/s), and 5% to 7% motility was observed when the quenched sample was warmed between the hands (40 K/s).

Further testing involved addition of an isotonic buffer solution to the semen sample in a 1:1 ratio. The solution was then placed into hematocrit tubes and rapidly quenched, and then warmed using various techniques. Using a large diameter tube and warming in 37 C methanol (60 K/s), 2% to 3% motility was observed. Using a large diameter tube and warming between the hands (40 K/s), 1% to 2% motility was observed. Using a small diameter tube and warming in 37 C methanol (60 K/s), approximately 1% motility was observed. Using a small diameter tube and hand warming (40 K/s), approximately 2% motility was observed. In an experiment in which a dilute sample was applied to a room temperature diamond wafer which was then immersed in liquid nitrogen to quench the sample, the sample was warmed by applying the diamond wafer to a room temperature copper block (75 K/s). Approximately 1% motility of the cells was observed.

While the invention has been shown and described with respect to certain embodiments and examples, it is understood that numerous variations and alternatives are contemplated as being within the scope of the invention. For example, and without limitation, it is considered that any biologically active material or substance may be preserved using the method as set forth above, and that the method is not limited to the specific substances set forth. Further, while the invention has been described in connection with application of the liquid to either a flat surface or containment within a tube for rapid quenching, it is understood that the liquid may be applied to virtually any type of surface for rapid quenching. While the rapid quenching process has been described as utilizing liquid nitrogen as the rapid cooling source, it is understood that any other method of quickly lowering the temperature of a substance may be employed. It is also understood that the cooling and warming rates set forth are representative of rates that have been found to be successful, and that other rates may be acceptable to preserve viability of the biologically active material. Further, while the method of the present invention is believed to be successful due to the vitrification of the biologically active material, it is understood that the cooling and heating of the material may result in a certain amount of crystallization. Total vitrification of the material is not absolutely necessary for success, as long as crystallization of the entire quantity of the material is avoided.

As noted previously, a significant advantage of the invention is that cryopreservation of biologically active material is accomplished without the use of cryoprotective agents or substances. However, it should be understood that the method of the invention also contemplates the use of certain amounts of cryoprotective substances if desired to facilitate transformation of the biologically active material to a glassy state. In all cases, however, the use of any such cryoprotective substance is in amounts significantly less than in the prior art, wherein such cryoprotective substances require lengthy de-perfusion processes and are used in amounts that have a deleterious effect on the biologically active material when returned to the liquid state from the glassy state. In the event cryoprotective substances are used in the method of the present invention, such substances may be used in sufficiently small amounts that de-perfusion is not required, or may be of the type that do not require de-perfusion. Further, such cryoprotective substances may be used in amounts such that any required de-perfusion process can be accomplished relatively quickly.

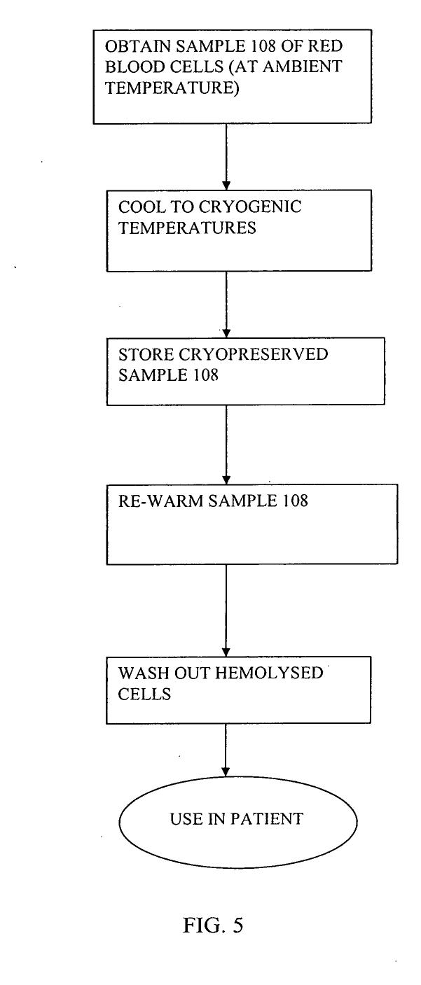

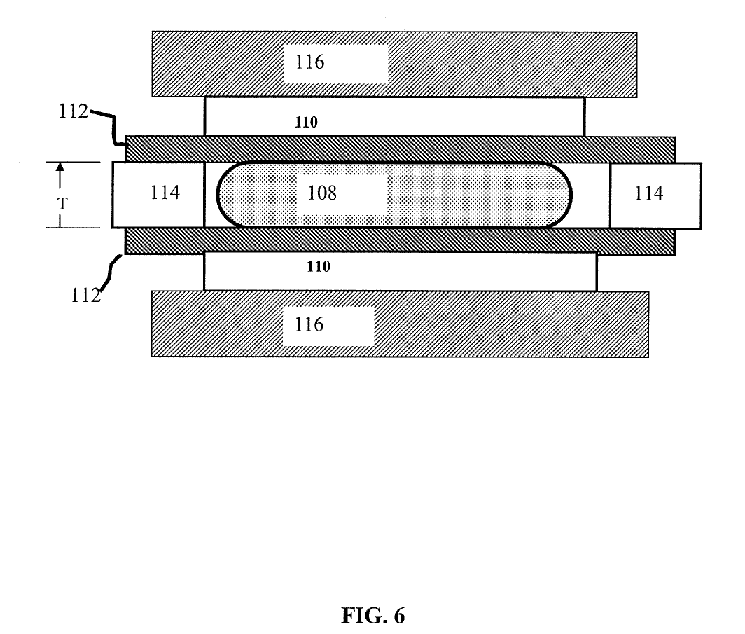

FIGS. 5-9 illustrate an embodiment of an apparatus and a method for cryopreserving and recovering human red blood cells according to the present invention. The apparatus and method shown in FIGS. 5-9 is similar in many ways to the illustrated embodiments of FIGS. 1A-4D described above. Accordingly, with the exception of mutually inconsistent features and elements between the embodiment of FIGS. 5-9 and the embodiments of FIGS. 1A-4D, reference is hereby made to the description above accompanying the embodiments of FIGS. 1A-4D for a more complete description of the features and elements (and the alternatives to the features and elements) of the embodiment of FIGS. 5-9. Features and elements in the embodiment of FIGS. 5-9 corresponding to features and elements in the embodiments of FIGS. 1A-4D are numbered in the 100 series.

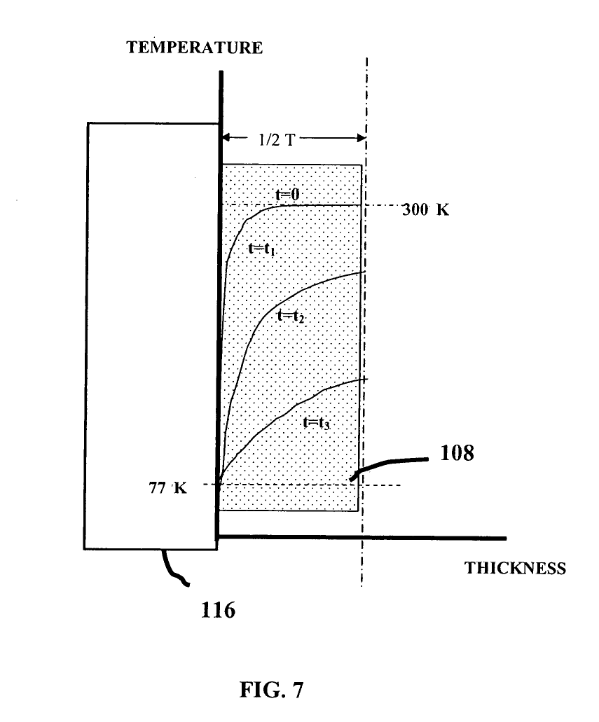

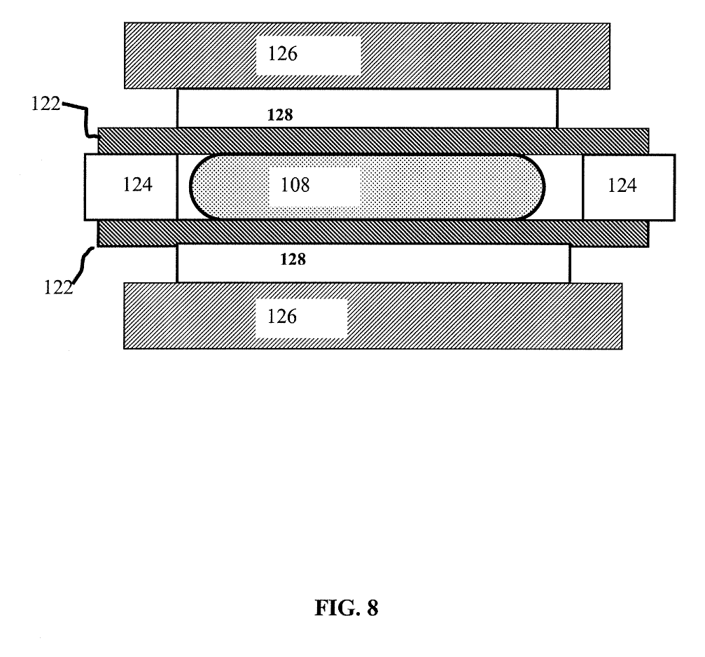

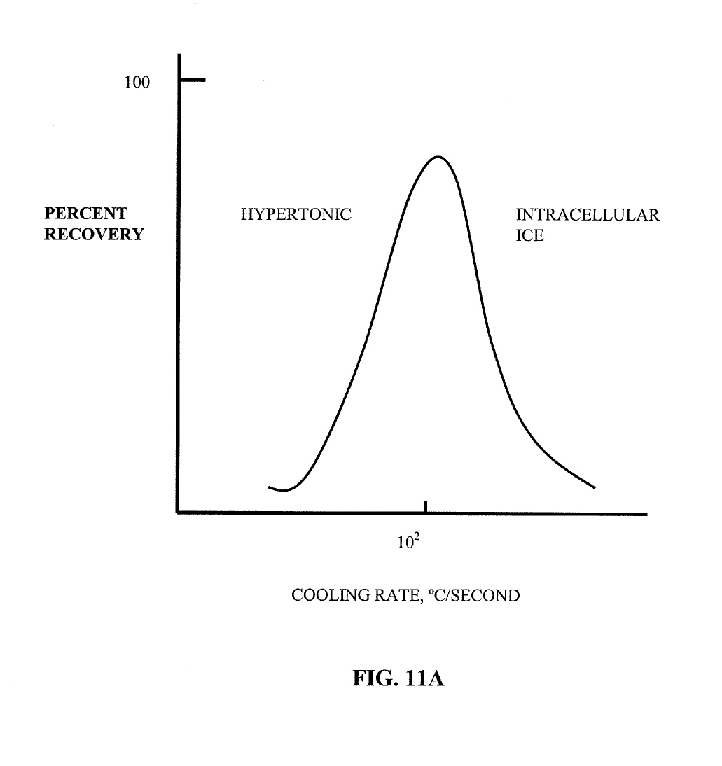

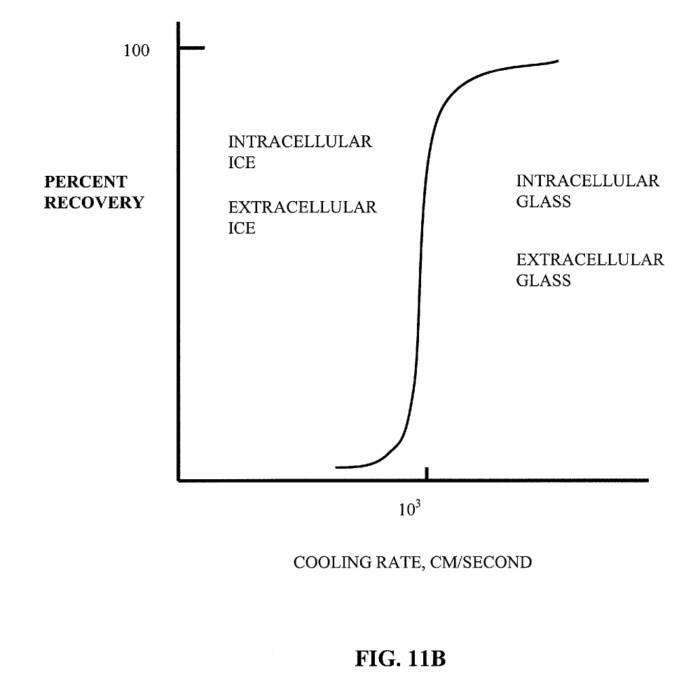

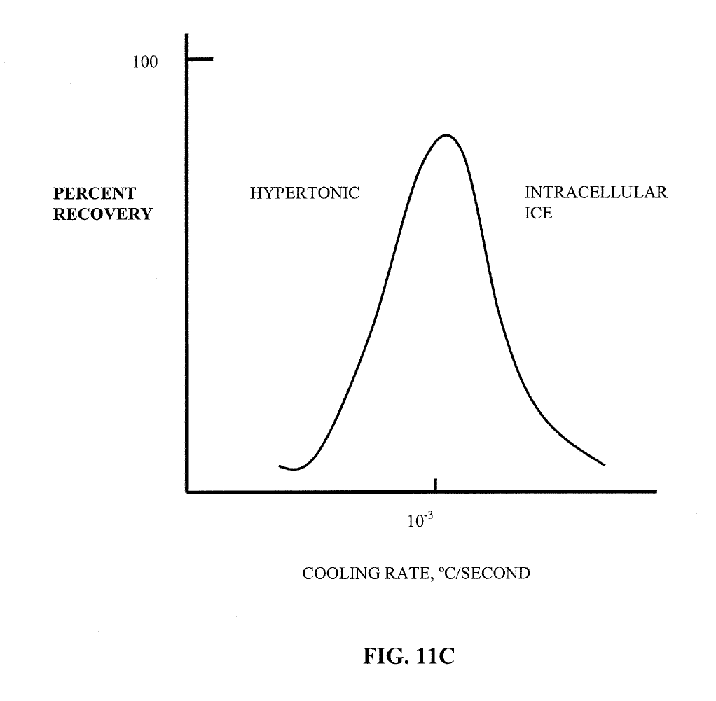

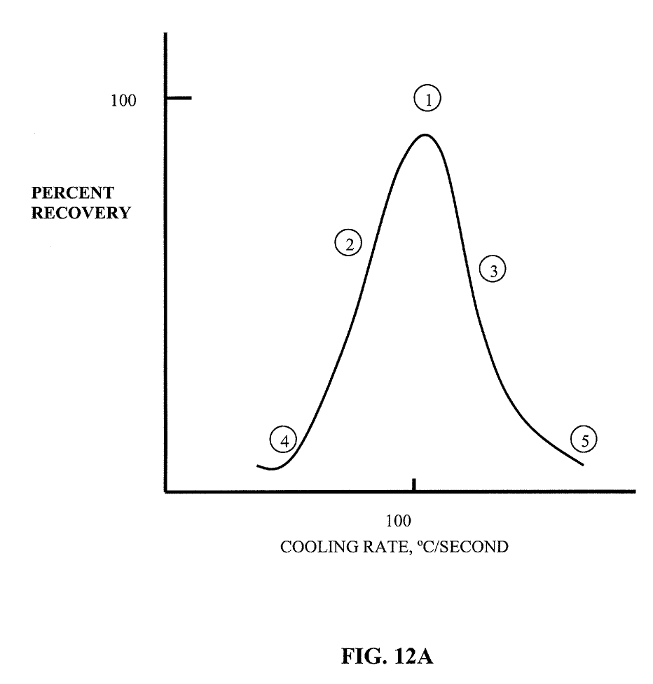

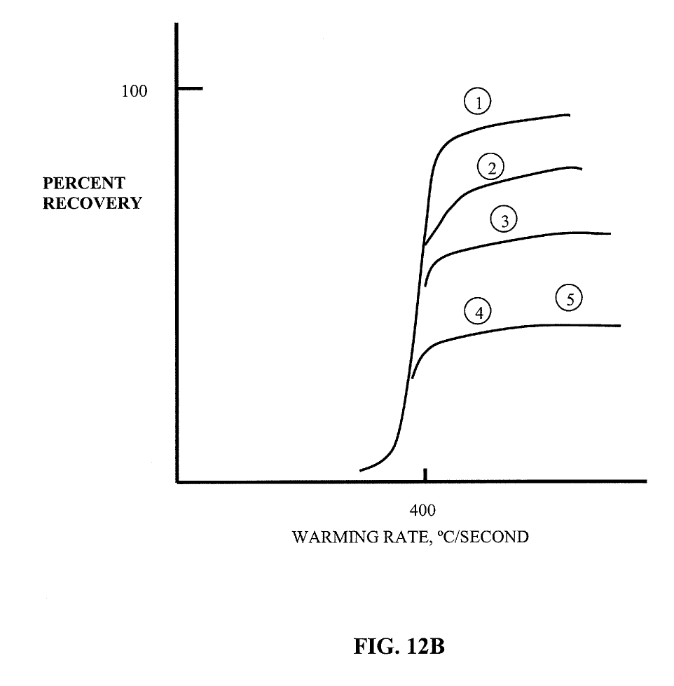

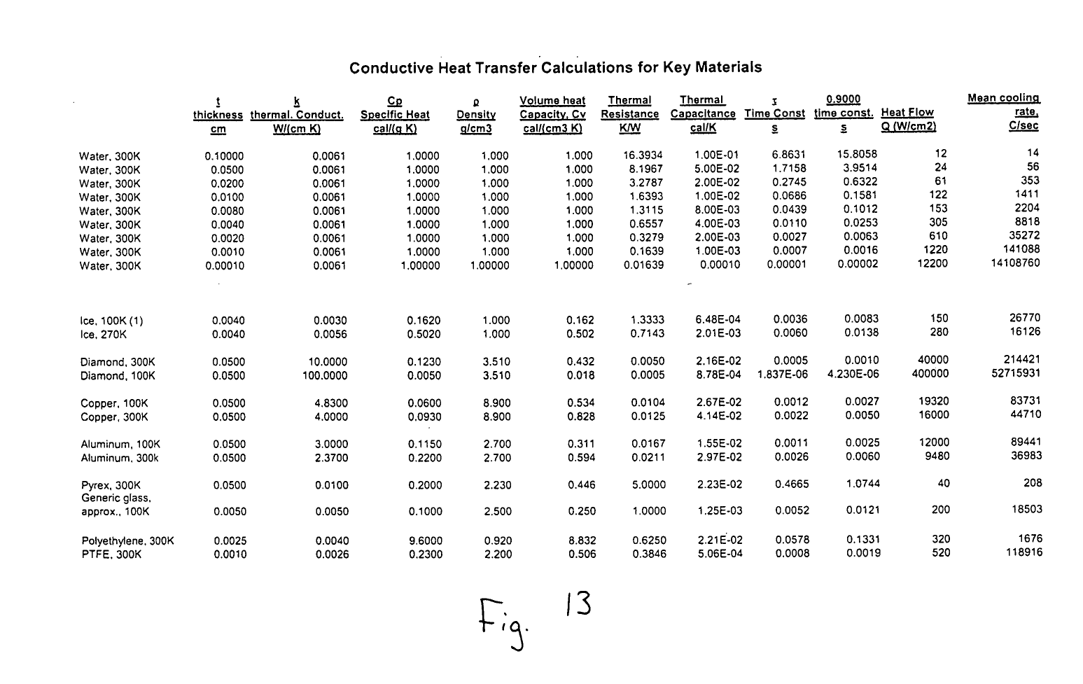

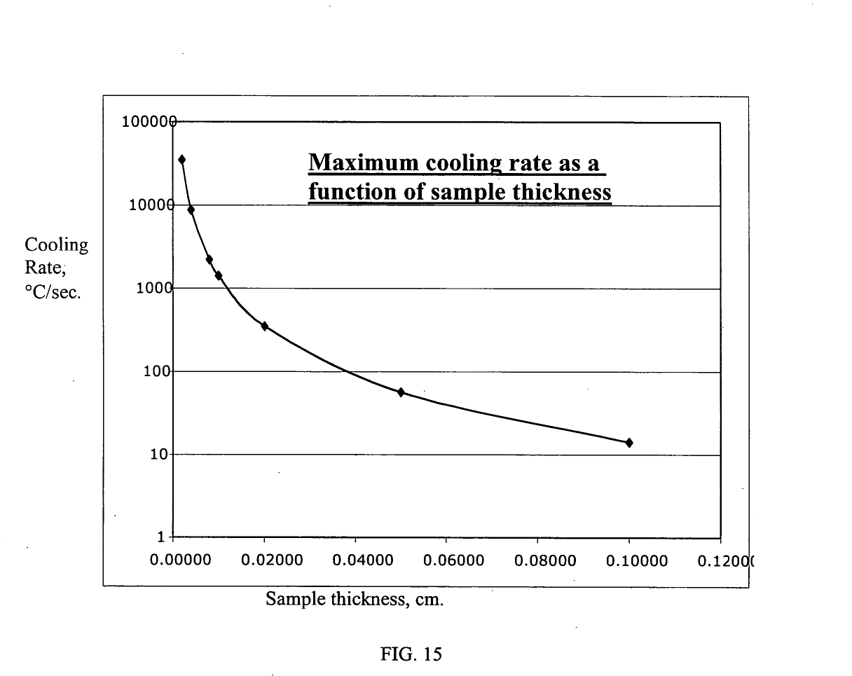

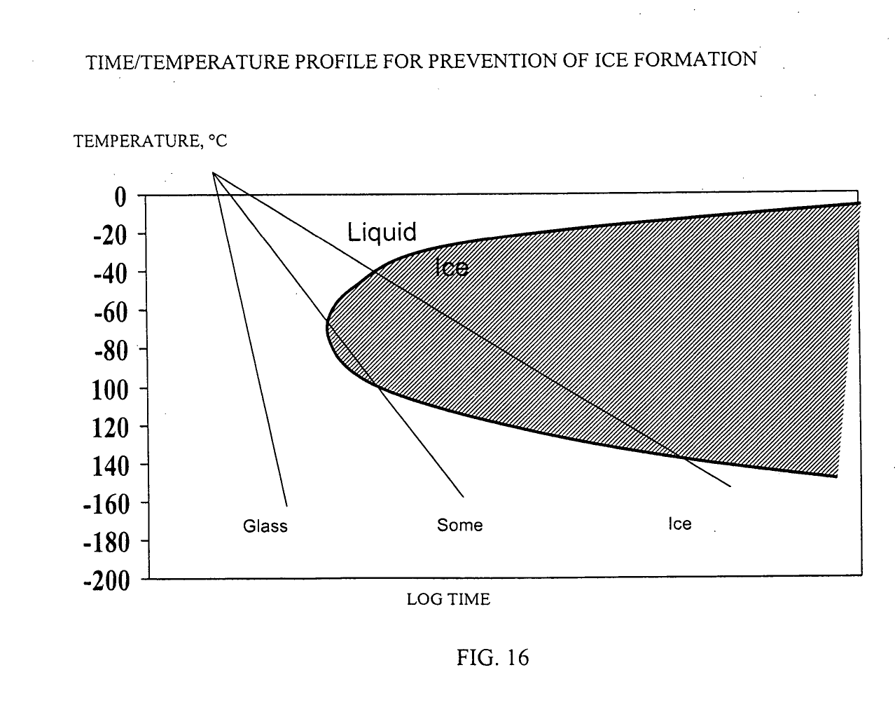

As shown in FIG. 5, a sample 108 including a volume of a fluid having a number of human red blood cells can be rapidly cooled in an environment substantially free from glycerol to cryogenic temperatures at a rate sufficient to provide a glassy formation substantially free from crystal lattice structures. The cooling rate is selected to avoid osmotic cell death and to prevent intracellular ice death. In some embodiments and as explained in more detail below, the red blood cells in the sample 108 can be cryogenically cooled at a rate of between about 20° C. and about 100° C. per second (see FIGS. 7, 11A, 11B, 12A, 12B, 15, and 16). Alternatively, samples 108 can be cooled at a rate of between about 35° C. and about 80° C. per second to achieve highly advantageous recovery rates. In other embodiments, samples 108 can be cooled at a rate of 40° C. per second to achieve highly advantageous recovery rates. In other embodiments, the red blood cells in the sample 108 can be cryogenically cooled at different rates depending on one or more the sample thickness T, the sample volume, and the cooler 110 being used.

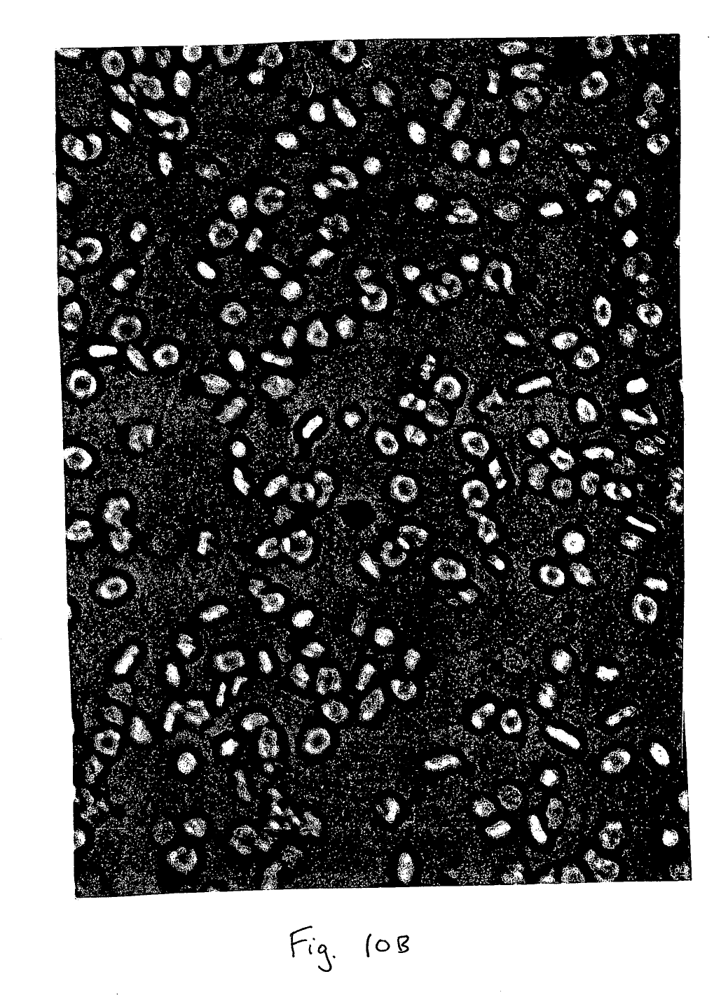

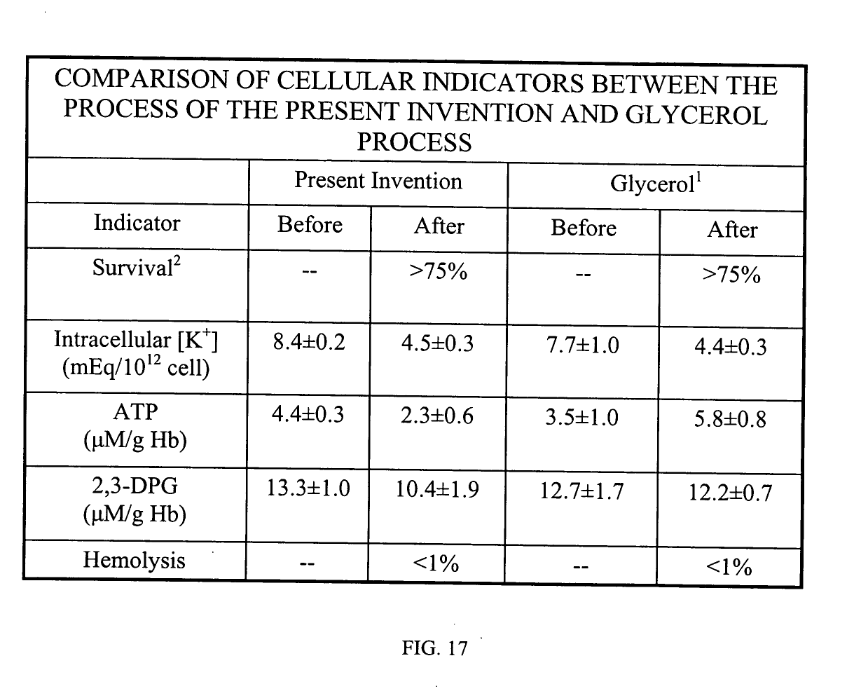

The frozen sample 108 can then be stored indefinitely or substantially indefinitely at a temperature of between about −40° C. and about −196° C. without causing substantial cell damage. However, it should be understood that one or more red blood cells in a single sample 108 can be damaged or destroyed during the process of the present invention, while at least a majority (and in some embodiments (see FIGS. 10, 11A, 11B, 12A, 12B, and 17) at least 75% of the cells in a sample 108) can be recovered using the method and the apparatus of the present invention.

At a desired time and place, the sample 108 can be rapidly re-warmed to an ambient temperature to recover the frozen cells. Hemolysed cells are then removed and the sample 108 can be administered to a patient. In some embodiments, a sample 108 frozen according to some embodiments of the present invention can be re-warmed and prepared for use in a patient in between about three minutes and about six minutes.

As shown in FIG. 6, a sample 108 can be cryogenically frozen using a cooler 110 including at least one planar film 112 formed from one or more thermally conductive materials, such as, for example, diamond, silicate glass, polymer, copper, aluminum, etc. In the illustrated embodiment of FIG. 6, the sample 108 is supported between a pair of substantially parallel films 112. In other embodiments, the cooler 110 can include one, three, or more films 112 having a variety of relative orientations and configurations including parallel, partially askew, normal, etc.

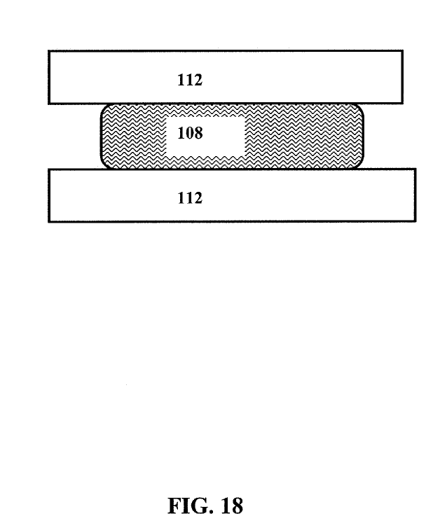

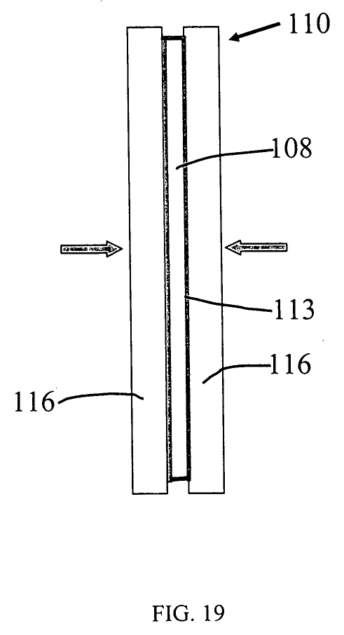

In some embodiments, the film or films 112 can be removed from the cooler 110 to facilitate transportation and/or storage of a sample 108 supported on the film 112 or between the films 112. In some embodiments, such as the illustrated embodiment of FIGS. 18 and 19, the film 112 can be formed of a polymeric material and can at least partially define a bag 113, which can substantially enclose a sample 108. In some such embodiments, the sample 108 can be stored and/or transported in the bag 113 before, during, and after the freezing and re-warming steps of the cryogenic preservation process of the present invention. In embodiments such as the illustrated embodiment of FIGS. 18 and 19, the bag 113 can also or alternatively be inserted into a cooler 110 and/or a heater 120 to freeze and/or re-warm the sample 108 supported in the bag 113.

With reference to FIG. 6, the cooler 110 can also include one or more spacers 114 positioned along a surface of a film 112 (e.g., the bottom film 112 in FIG. 6) to maintain a substantially constant thickness T of the sample 108. In some embodiments, the spacers 114 can maintain a constant thickness T of the sample 108 of between about 200 microns and about 2000 microns. In other embodiments, the spacers 114 can maintain a substantially constant thickness T of the sample 108 of between about 500 microns and about 1000 microns. In still other embodiments, the spacers 114 can maintain a predetermined thickness T of the sample 108 of at least about 200 microns.

In some embodiments, the cooler 110 can also include spacers 114 oriented along the film to control fluid flow along the film 112 and through the cooler 110. In the illustrated embodiment of FIG. 6, the cooler 110 includes a pair of spacers 114 located at opposite sides of a bottom film 112 and straddling the sample 108 to maintain a substantially constant distance between the pair of films 112. In other embodiments, one, three, or more spacers 114 can be positioned along one or more films 112 to maintain a substantially constant thickness T of the sample 108 throughout the cooler 110 and/or to at least partially control fluid flow of the sample 108 in the cooler 110.

As shown in FIG. 6, a sample 108 can be spread between the pair of films 112 and between spacers 114 by compressing the sample 108 between the films 112 to force the sample 108 to spread outwardly between the films 112. Alternatively or in addition, surface tension can be used to limit the spread the sample 108 between the films 112 or across a single film 112.

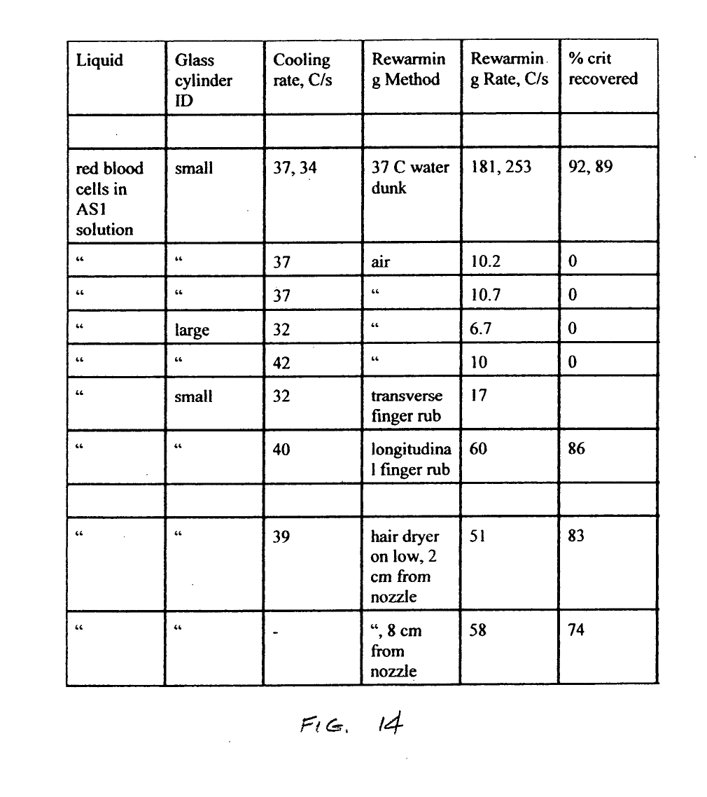

The cooler 110 can also include cooling plates 116. The cooling plates 116 can be positioned on opposite sides (e.g., upper and lower sides as shown in FIG. 6) of the sample 108 and can be formed of one or more highly thermally conductive materials, such as, for example, aluminum, copper, and the like (see FIG. 13). In other embodiments, the cooler 110 can include a single cooling plate 116, or alternatively, the cooler 110 can include three or more cooling plates 116 engageable with one, two, three, or more sides of the sample 108.

The cooling plate(s) 116 can be sized to operate as thermal sinks or thermal reservoirs such that heat can be relatively quickly conducted to the cooling plates 116 from objects coming in contact with the cooling plates 116. More particularly, the cooling plates 116 are formed and sized so as to achieve the sample cooling rates mentioned above for given sample sizes and given sample types.

The cooling plate(s) 116 can also be supported in the cooler 110 for movement relative to one or more films 112 and/or relative to a sample 108 supported in the cooler 110. In the illustrated embodiment of FIG. 6, each of the cooling plates 116 are supported for movement toward an engaged position (shown in FIG. 6), in which the cooling plates 116 are in conductive thermal engagement with films 112 located on opposite sides of the sample 108, and a disengaged position (not shown), in which the cooling plates 116 are moved away from the films 112 and out of conductive thermal engagement with the sample 108.

In some embodiments, such as the illustrated embodiment of FIG. 6, an interlayer 118 can be positioned between a film 112 and a cooling plate 116, or alternatively, an interlayer 118 can be positioned between each of the films 112 and the cooling plates 116 to improve and/or increase heat transfer between the cooling plate(s) 116 and the film(s) 112. In some such embodiments, a fluid interlayer 118 is positioned on an exterior surface of the film(s) 112 to substantially fill any voids, inequalities, or recesses located along the exterior surface of the films(s) 112, thereby preventing air pockets and other areas of reduced thermal conductivity from being formed along an interface between the film(s) 112 and the cooling plate(s) 116. In some embodiments, the exterior surfaces of one or both of the film(s) 112 and the cooling plate(s) 116 are polished to substantially remove voids, inequalities, or recesses to further reduce or substantially prevent air pockets and other areas of reduced thermal conductivity from being formed along an interface between the film(s) 112 and the cooling plate(s) 116.

The fluid interlayer 118 can be a fluid having a greater thermal conductivity than air and, in some embodiments, can include water or a fluid having a thermal conductivity similar to the thermal conductivity of water. The fluid interlayer 118 can also have a thickness of 10 microns or less. For example, in some embodiments, the fluid interlayer 118 can include a concentration of about 40% by weight alcohol.

As shown in FIG. 7, the sample size is maintained at a desired thickness T so that thermal energy can be quickly and uniformly transferred from the sample 108 to the cooling plate(s) 116. As shown graphically in FIG. 7, in embodiments in which a pair of cooling plates 116 are engageable with opposite sides of a sample 108, a sample 108 having a thickness T of between about 40 microns and about 100 microns can be completely and uniformly cooled to a temperature of between −40° C. to −196° C. in less than about two seconds. In some embodiments, highly effective results have been achieved in samples 108 cooled to a temperature below about −80° C. In other embodiments, highly effective results have been achieved in samples 108 cooled to a temperature below about −120° C. In some such embodiments, the temperature of the sample 108 is uniform and constant throughout the sample 108 when the temperature of the sample approaches the temperature of the cooling plate(s) 116.

After a sample 108 is cryogenically cooled and preserved at a cryogenic temperature (e.g., between about −40° C. and about −196° C. for human red blood cells), the sample 108 can be stored or transported relatively easily without damaging the cells as long as the sample 108 is maintained within a desired storage temperature range (e.g., between about −40° C. and about −196° C. for human red blood cells).

When the sample 108 is needed, the sample 108 can be re-warmed in a heater 120 from the desired storage temperature range to an ambient temperature at a warming rate sufficient to prevent substantial cell damage (e.g., between about 20° C. and about 100° C. per second for human red blood cells). Alternatively, samples 108 can be re-warmed at a rate of between about 35° C. and about 80° C. per second to achieve highly advantageous recovery rates. In other embodiments, samples 108 can be re-warmed at a rate of at least 40° C. per second to achieve highly advantageous recovery rates.

As shown in FIG. 8, the heater 120 can include at least one planar film 122 formed from one or more thermally conductive materials, such as, for example, diamond, glass, copper, aluminum, polymer, etc. In the illustrated embodiment of FIG. 8, the sample 108 is supported between a pair of substantially parallel films 122. In other embodiments, the heater 120 can include one, three, or more films 122 having a variety of relative orientations and configurations including parallel, partially askew, normal, etc. In some embodiments, the same planar film(s) can be used in both the cooler 110 and the heater 120. In other embodiments, different films are used in the cooler 110 and the heater 120.

The heater 120 can also include one or more spacers 124 positioned along a surface of a film 122 (e.g., the bottom film 122 in FIG. 8) to maintain a constant thickness T of the sample 108 during warming and to prevent the sample 108 from being unintentionally compressed during re-warming. In the illustrated embodiment of FIG. 8, the heater 120 includes a pair of spacers 124 located at opposite sides of a bottom film 122 and straddling the sample 108 to maintain a constant distance between the pair of films 122. In other embodiments, one, three, or more spacers 124 can be positioned along one or more films 122 to maintain a substantially constant thickness T of the sample 108 throughout the heater 120 during the entire re-warming sequence.

The heater 120 can also include heating plates 126. The heating plates 126 can be positioned on opposite sides (e.g., upper and lower sides as shown in FIG. 8) of the sample 108 and can be formed of one or more highly thermally conductive materials, such as, for example, aluminum, copper, other metals, silver, diamond, and the like (see FIG. 13). In other embodiments, the heater 120 can include a single heating plate 126, or alternatively, the heater 120 can include three or more heating plates 116 engageable with one, two, three, or more sides of the sample 108.

The heating plate(s) 126 can be sized to operate as thermal sinks or thermal reservoirs such that heat energy can be relatively quickly conducted from the heating plate(s) 126 to objects coming in contact with the heating plates 126. The heating plate(s) 126 can also be supported in the heater 120 for movement relative to one or more films 124 and/or relative to a sample 108 supported in the heater 120. In the illustrated embodiment of FIG. 8, each of the heating plates 126 are supported for movement toward an engaged position (shown in FIG. 8), in which the heating plates 126 are in conductive thermal engagement with films 122 located on opposite sides of the sample 108, and a disengaged position (not shown), in which the heating plates 126 are moved away from the films 122 and out of conductive thermal engagement with the sample 108.

In some embodiments, such as the illustrated embodiment of FIG. 8, an interlayer 128 can be positioned between a film 122 and a heating plate 126, or alternatively, an interlayer 128 can be positioned between each of the films 122 and the heating plates 126 to improve and/or increase heat transfer between the heating plate(s) 126 and the film(s) 122. In some such embodiments, a fluid interlayer 128 is positioned on an exterior surface of the film(s) 122 to substantially fill any voids, inequalities, or recesses located along the exterior surface of the films(s) 122, thereby preventing air pockets and other areas of reduced thermal conductivity from being formed along an interface between the film(s) 122 and the heating plate(s) 126. In some embodiments, the fluid interlayer 128 can have a thickness of less than 10 microns. In embodiments having two or more interlayers 128, each of the interlayers 128 can have a thickness of less than 10 micros, or alternatively, each of the interlayers 128 can have a different thickness. In some embodiments, the exterior surfaces of one or both of the film(s) 122 and the heating plate(s) 126 are polished to substantially remove voids, inequalities, or recesses to further reduce or substantially prevent air pockets and other areas of reduced thermal conductivity from being formed along an interface between the film(s) 122 and the heating plate(s) 126.

The fluid interlayer 128 can be a fluid having a greater thermal conductivity than air and, in some embodiments, can include water or a fluid having a thermal conductivity similar to the thermal conductivity of water. The fluid interlayer 128 can also have a thickness of 10 microns or less. For example, in some embodiments, the fluid interlayer 118 can include a concentration of about 40% by weight alcohol.

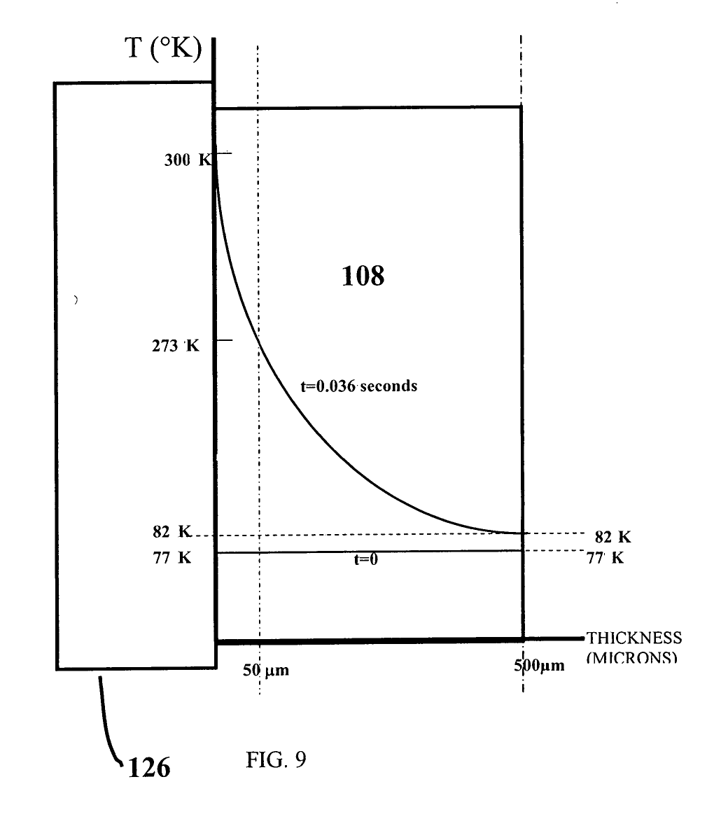

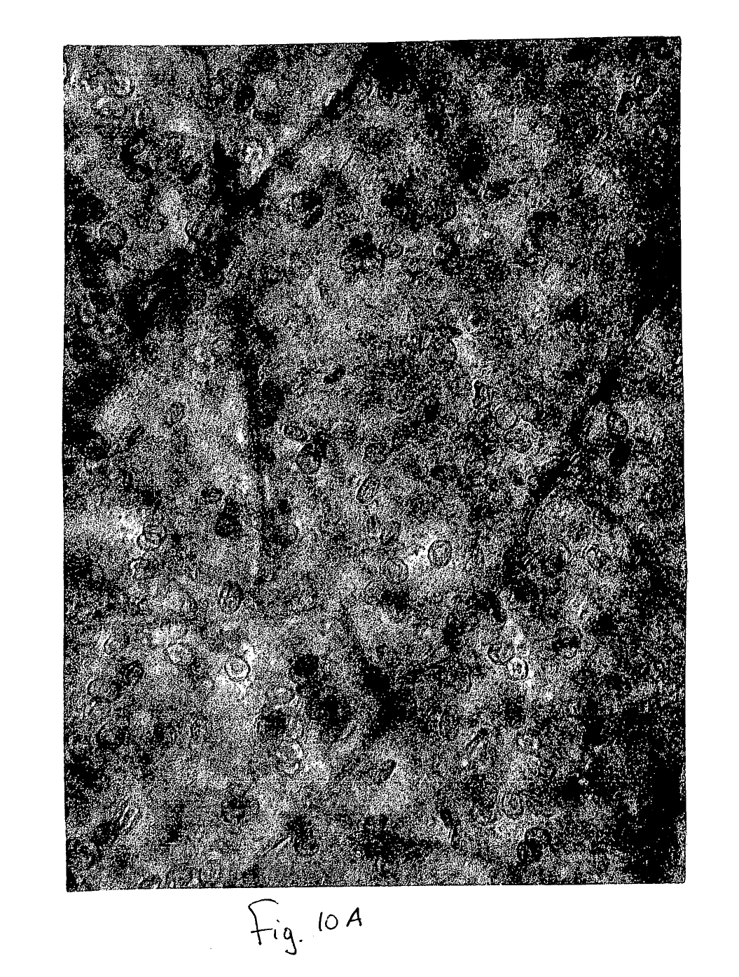

As shown in FIG. 9, the sample size is maintained at a desired thickness T so that thermal energy can be quickly and uniformly transferred from the heating plate(s) 126 to the sample 108. As shown graphically in FIG. 9, in embodiments in which a pair of heating plates 126 are engageable with opposite sides of a sample 108, the outer 50 microns of a sample 108 having a thickness T of between about 100 microns and about 1000 microns can be completely and uniformly heated to a temperature of about 273 K in about 0.036 seconds.

As shown in FIGS. 10A, 10B, 11A, 11B, 12A, and 12B, a majority of the human red blood cells in a sample 108 cryogenically frozen and re-warmed according to the method and using the cooler 110 and the heater 120 of the embodiment of FIGS. 5-9 can be recovered. In some such embodiments, at least about 85% of the red blood cells in the sample 108 can be recovered.

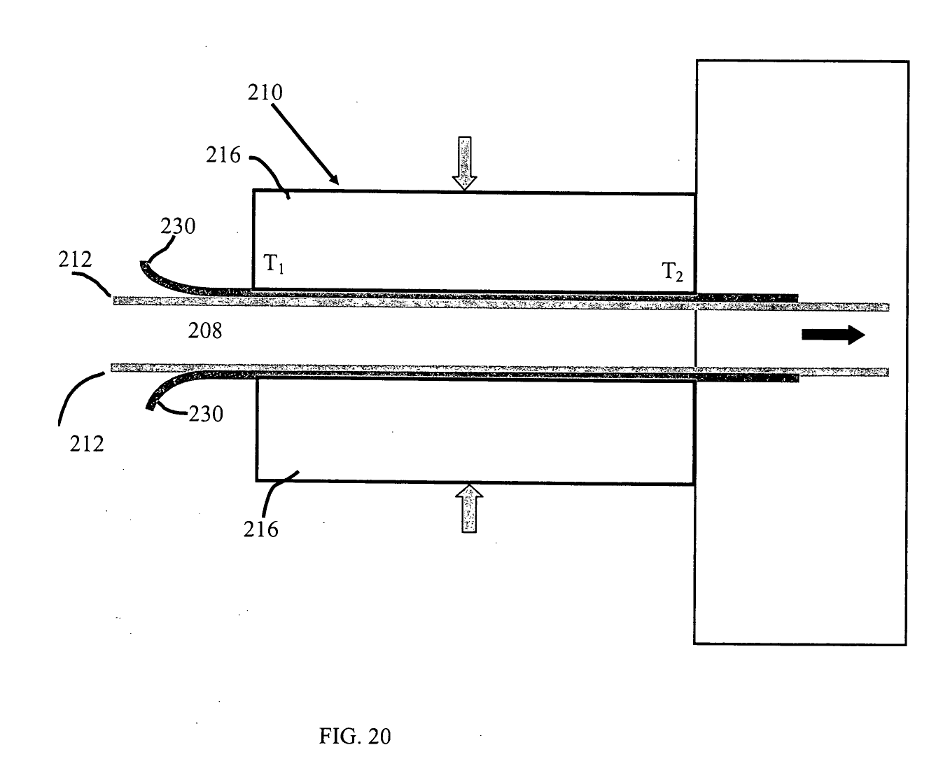

FIG. 20 illustrates another embodiment of an apparatus and a method for cryopreserving and recovering human red blood cells according to the present invention. The apparatus and method shown in FIG. 20 is similar in many ways to the illustrated embodiments of FIGS. 1A-9, 18, and 19 described above. Accordingly, with the exception of mutually inconsistent features and elements between the embodiment of FIG. 20 and the embodiments of FIGS. 1A-9, 18, and 19, reference is hereby made to the description above accompanying the embodiments of FIGS. 1A-9, 18, and 19 for a more complete description of the features and elements (and the alternatives to the features and elements) of the embodiment of FIG. 20. Features and elements in the embodiment of FIG. 20 corresponding to features and elements in the embodiments of FIGS. 1A-9, 18, and 19 are numbered in the 200 series.

As shown in FIG. 20, a sample 208 can be supported on one or between two or more films 212, which can be feed between inlet guides 230 and into a cooler 210. In the cooler 210, one or more cooling plates 216 can be moved into contact with the film 212 to transfer heat from the sample 208 to the cooling plate(s) 216. In some such embodiments, the sample 208 can be cooled as the sample 208 travels through the cooler 210 in a travel direction. The frozen sample 208 can then be moved into a cold storage area where the sample 208 can be stored for extended periods of time at a temperature of between about −80° C. and about −196° C. When the sample 208 is needed, the sample 208 can be re-warmed or recovered in a heater as described above with respect to FIGS. 5-9. In some embodiments, the sample 208 can be directed in a reverse direction through the cooler 210 and the cooling plates 216 can be heated so that the cooler 210 can function as a heater to re-warm the sample 208. In some embodiments, a number of different samples 208 can be cooled in the cooler 210 in a relatively short period of time.

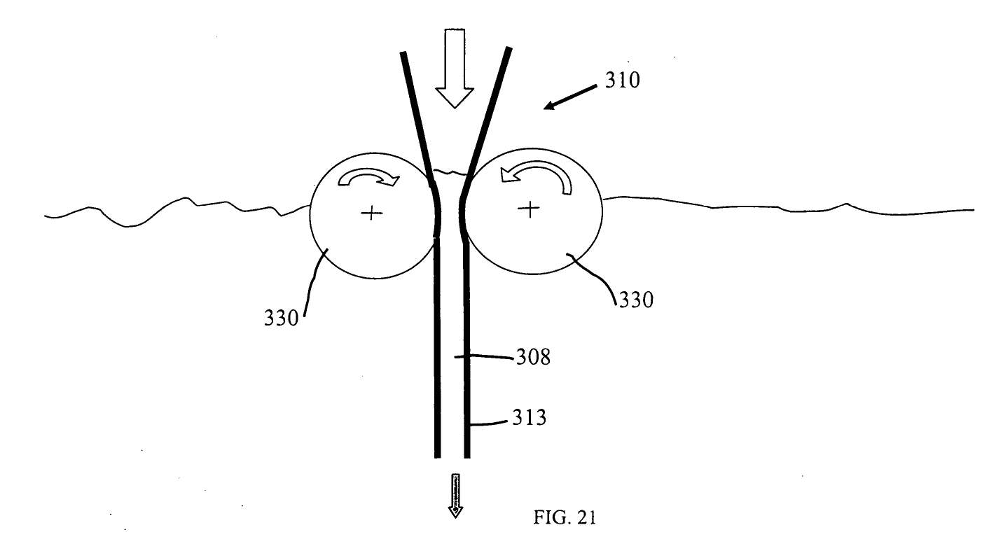

FIG. 21 illustrates another embodiment of an apparatus and a method for cryopreserving and recovering human red blood cells according to the present invention. The apparatus and method shown in FIG. 21 is similar in many ways to the illustrated embodiments of FIGS. 1A-9 and 18-20 described above. Accordingly, with the exception of mutually inconsistent features and elements between the embodiment of FIG. 21 and the embodiments of FIGS. 1A-9 and 18-20, reference is hereby made to the description above accompanying the embodiments of FIGS. 1A-9 and 18-20 for a more complete description of the features and elements (and the alternatives to the features and elements) of the embodiment of FIG. 21. Features and elements in the embodiment of FIG. 21 corresponding to features and elements in the embodiments of FIGS. 1A-9 and 18-20 are numbered in the 300 series.

As shown in FIG. 21, a sample 308 can be supported in a bag 313 (or alternatively between a pair of films), which can be feed between inlet guides (e.g., rollers, wheels, and the like) 330 and into a cooler 310. In some embodiments, such as the illustrated embodiment of FIG. 21, a pair of inlet guides 330 can be positioned on opposite sides (e.g., left and right sides as shown in FIG. 21) of the sample 308 and can be formed of one or more highly thermally conductive materials, such as, for example, aluminum, copper, and the like. In other embodiments, the cooler 310 can include a single inlet guide 330, or alternatively, the cooler 310 can include three or more inlet guides 330 engageable with one, two, three, or more sides of the sample 308.

The inlet guides 330 can be sized to operate as thermal sinks or thermal reservoirs such that heat energy can be relatively quickly conducted to the inlet guides 330 from objects coming in contact with the inlet guides 330. In some embodiments, the inlet guides 330 can be immersed or at least partially immersed in liquid nitrogen or another cryogenically cooled fluid to maintain the temperature of the inlet guides 330 within a desired temperature range.

In some such embodiments, the sample 308 can be cooled as the sample 308 travels through the cooler 310 in a travel direction between the cooling guides 330. The frozen sample 308 can then be moved into a cold storage area where the sample 308 can be stored for extended periods of time at a temperature of between about −80° C. and about −196° C. When the sample 308 is needed, the sample 308 can be re-warmed or recovered in a heater as described above with respect to FIGS. 5-9.

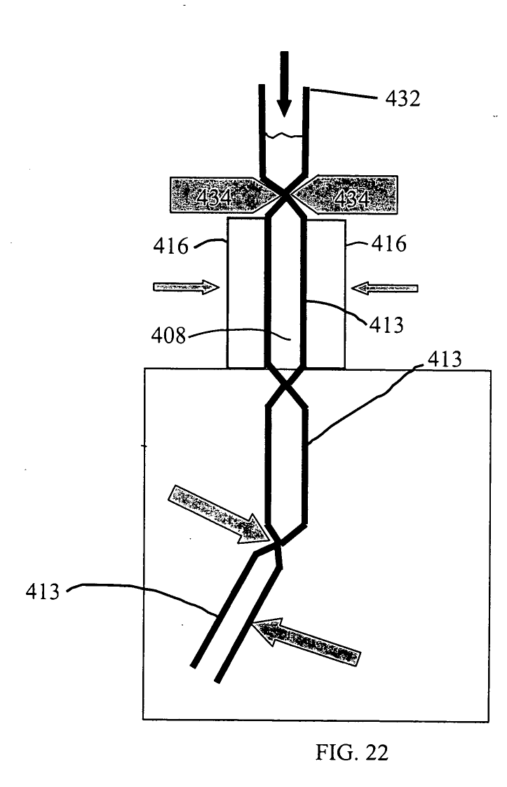

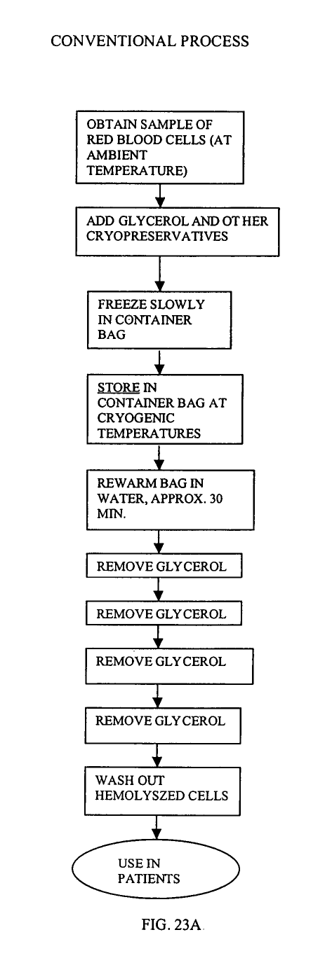

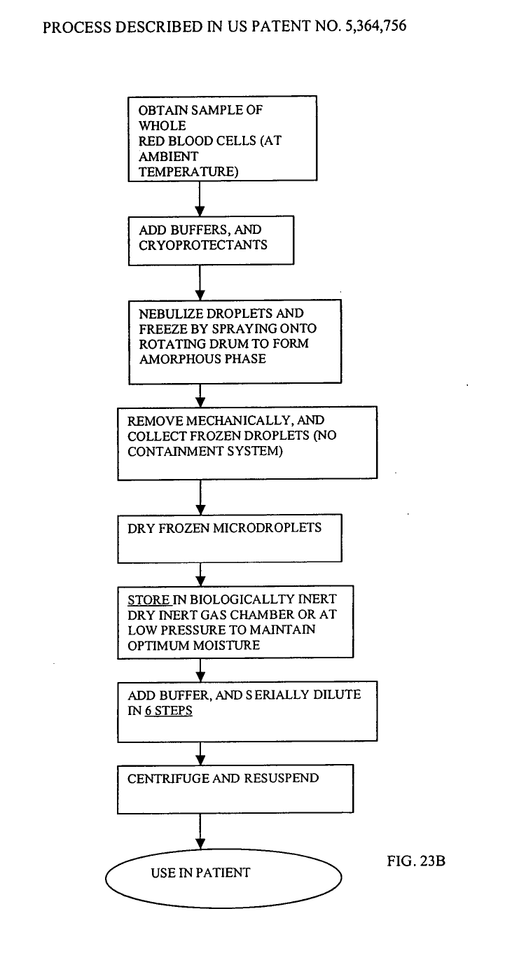

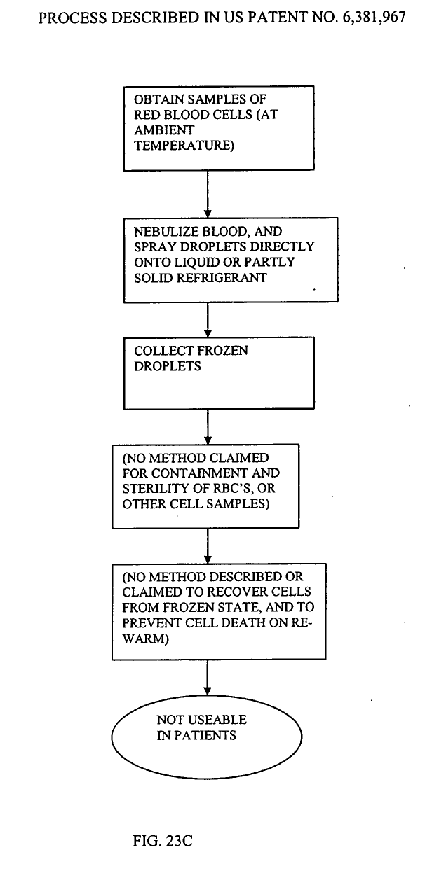

FIG. 22 illustrates another embodiment of an apparatus and a method for cryopreserving and recovering human red blood cells according to the present invention. The apparatus and method shown in FIG. 22 is similar in many ways to the illustrated embodiments of FIGS. 1A-9 and 18-21 described above. Accordingly, with the exception of mutually inconsistent features and elements between the embodiment of FIG. 22 and the embodiments of FIGS. 1A-9 and 18-21, reference is hereby made to the description above accompanying the embodiments of FIGS. 1A-9 and 18-21 for a more complete description of the features and elements (and the alternatives to the features and elements) of the embodiment of FIG. 22. Features and elements in the embodiment of FIG. 22 corresponding to features and elements in the embodiments of FIGS. 1A-9 and 18-21 are numbered in the 400 series.

As shown in FIG. 22, a sample 408 can be supported in a film 412 formed into a tube 432, which can be feed between inlet guides (not shown) and into a cooler 410. At predetermined intervals, the tube 432 can be pinched between a pair of actuators 434 (rollers, wheels, reciprocating fingers, and the like). The predetermined interval can be adjusted to alter the sample size as needed. In some embodiments, opposite walls of the tube 432 can be bonded together between the pair of actuators 434 to form individual bags 413 sealed at front and rear ends.

The tube 432 with two or more interconnected bags 413 can then be feed toward a cooler 410 and between a pair of cooling plates 416. In some such embodiments, the samples 408 in each of the bags 413 can be cooled as the bags 413 travel through the cooler 410 in a travel direction between the cooling plates 416. The bags 413 containing frozen samples 408 can then be moved into a cold storage area where the sample 408 can be stored for extended periods of time at a temperature of between about −80° C. and about −196° C. In some embodiments, the individual samples 408 can be stacked together in a cold storage area to minimize storage space.

When a sample 408 is needed, a bag 413 including a single, individually marked sample 408 can be removed from storage area and can be re-warmed or recovered in a heater as described above with respect to FIGS. 5-9.

The embodiments described above and illustrated in the figures are presented by way of example only and are not intended as a limitation upon the concepts and principles of the present invention. Various features and advantages of the invention are set forth in the following claims.

1. A method of preserving human red blood cells, the method comprising the acts of:
cryogenically freezing a plurality of human red blood cells suspended in a fluid at a rate of 20° C. to 100° C. per second;
maintaining a predetermined thickness of the fluid between a pair of plates during freezing of the plurality of red blood cells; and
warming the plurality of cryogenically frozen red blood cells to an ambient temperature to recover at least some of the plurality of red blood cells.

2. The method of claim 1, wherein the pair of plates is a first pair of plates, and wherein warming the plurality of red blood cells includes warming the plurality of red blood cells between a second pair of plates.

3. The method of claim 1, wherein the plurality of red blood cells are cryogenically frozen in an environment substantially free of glycerol.

4. The method of claim 1, wherein the predetermined thickness is at least 200 microns.

5. The method of claim 1, wherein the predetermined thickness is less than 2000 microns.

6. The method of claim 1, wherein warming the plurality of red blood cells includes warming the plurality of red blood cells at a rate of at least 40° C. per second.

7. The method of claim 1, wherein cryogenically freezing the plurality of red blood cells includes cryogenically freezing the plurality of red blood cells in a bag supported between the pair of plates.

8. The method of claim 1, further comprising spreading the plurality of red blood cells between the pair of plates without shearing the plurality of red blood cells.

9. The method of claim 8, further comprising using surface tension to control a spread of the plurality of red blood cells between the pair of plates.

10. The method of claim 1, further comprising positioning a film across the fluid.

11. The method of claim 1, further comprising warming the plurality of cryogenically frozen red blood cells to recover at least a majority of the plurality of red blood cells.

12. The method of claim 10, further comprising applying a liquid interlayer to an exterior surface of the film to at least partially fill voids located along the exterior surface of the film to improve conductive heat transfer through the film.

13. The method of claim 12, wherein cryogenically freezing the red blood cells includes pressing one of the pair of plates against the liquid interlayer to cryogenically freeze the plurality of red blood cells in the fluid.

14. The method of claim 1, further comprising positioning spacers between the pair of plates to maintain a predetermined thickness of the fluid of less than 2000 microns.

15. A method of preserving human red blood cells, the method comprising the acts of:
spreading a fluid including a plurality of human red blood cells;
positioning a film across the fluid;
applying a liquid interlayer to an exterior surface of the film; and
pressing a cold plate against the liquid interlayer to cryogenically freeze the plurality of red blood cells in the fluid by thermal conduction.

16. The method of claim 15, wherein the cold plate is a first plate, wherein the fluid is supported between the first cold plate and a second cold plate, and further comprising positioning spacers between the first and second cold plates to maintain a thickness of the fluid of between 500 microns and 2000 microns.

17. The method of claim 16, wherein the thickness is less than 1000 microns.

18. The method of claim 15, wherein cryogenically freezing the plurality of red blood cells includes freezing the plurality of red blood cells at a rate of approximately 40° C. per second.

19. The method of claim 15, further comprising warming the red blood cells to an ambient temperature.

20. The method of claim 19, wherein warming the red blood cells includes warming the red blood cells by thermal conduction between a pair of plates to recover at least some of the plurality of red blood cells.

21. The method of claim 15, wherein the fluid is substantially free of glycerol.

22. The method of claim 15, further comprising warming the red blood cells at a rate of approximately 40° C. per second.

23. The method of claim 15, wherein cryogenically freezing the red blood cells includes cryogenically freezing the red blood cells in a bag supported on the cold plate.

24. The method of claim 15, wherein spreading the fluid includes spreading the fluid so as to avoid shearing the red blood cells.

25. The method of claim 15, further comprising using surface tension to spread the red blood cells.

26. The method of claim 15, wherein the cold plate is a first cold plate and the film is a first film positioned on a first side of the fluid, and further comprising the acts of positioning a second film across a second side of the fluid;
applying a liquid interlayer to an exterior surface of the second film; and
pressing a second cold plate against the liquid layer on the second film to cryogenically freeze the red blood cells in the fluid by thermal conduction.

27. A method of preserving human red blood cells, the method comprising the acts of:
spreading a fluid including a plurality of human red blood cells between a pair of substantially parallel plates so as to avoid shearing the red blood cells between the pair of plates, the fluid being substantially glycerol free;
cryogenically freezing the plurality of human red blood cells; and
warming the plurality of red blood cells to an ambient temperature.

28. The method of claim 27, further comprising positioning a film across the fluid.

29. The method of claim 28, further comprising applying a liquid interlayer to an exterior surface of the film.

30. The method of claim 29, wherein freezing the plurality of human red blood cells includes pressing one of the pair of plates against the liquid interlayer to cryogenically freeze the red blood cells in the fluid by thermal conduction.

31. The method of claim 27, further comprising positioning spacers between the pair of plates to maintain a predetermined thickness of the fluid of between 500 microns and 1000 microns.

32. The method of claim 27, wherein cryogenically freezing the plurality of red blood cells includes freezing the plurality of red blood cells at a rate of approximately 40° C. per second.

33. The method of claim 27, wherein the pair of plates is a first pair of plates, and wherein warming the plurality of red blood cells includes warming the plurality of red blood cells by thermal conduction between a second pair of substantially parallel plates.

34. The method of claim 27, wherein warming the plurality of red blood cells includes warming the plurality of red blood cells at a rate of approximately 40° C. per second.

35. The method of claim 27, wherein cryogenically freezing the red blood cells includes cryogenically freezing the red blood cells in a bag supported between the pair of plates.

36. The method of claim 27, further comprising using surface tension to spread the red blood cells.
